(19) United States
(12) Patent Application Publication
(10) Pub. No.: US 2015/0252873 A1
(43) Pub. Date: Sep. 10, 2015

(54) ROTARY OSCILLATION DAMPER

(71) Applicant: SÜDDEUTSCHE GELENKSCHEIBENFABRIK GMBH & CO. KG, Waldkraiburg (DE)

(72) Inventors: Bernd Scheper, Reichertsheim (DE); Marc Brandl, Burgkirchen (DE); Franz Kobus, Jettenbach (DE); Johann Loew, Garching (DE); Hueseyin Cabuk, Waldkraiburg (DE); Steffen Jerye, Haag (DE)

(73) Assignee: SÜDDEUTSCHE GELENKSCHEIBENFABRIK GMBH & CO. KG, Waldkraiburg (DE)

(21) Appl. No.: 14/597,739

(22) Filed: Jan. 15, 2015

(30) Foreign Application Priority Data
Mar. 10, 2014 (DE) 10 2014 003 574.3

(51) Int. Cl. F16F 7/108; F16F 7/10

(52) U.S. Cl. CPC F16F 15/1442; F16F 7/108

(57) ABSTRACT

The present invention relates to a rotary oscillation damper 10, particularly for a drivetrain of a motor vehicle, having at least one inner part 12 that can rotate around a rotational axis M, at least one damper mass 14 that is coaxial to the inner part 12 and is situated spaced radially apart from the inner part 12, and at least one spring mechanism 16 that produces a connection between the at least one inner part 12 and the at least one damper mass 14. According to the invention, the at least one inner part 12 and the at least one damper mass 14 can be connected by means of the at least one spring mechanism 16 in such a way that the at least one spring mechanism 16 has a predetermined radial prestressing.

The present invention relates to a rotary oscillation damper, particularly for a drivetrain of a motor vehicle. The rotary oscillation damper includes at least one inner part that can rotate around a rotational axis, at least one damper mass that is coaxial to the inner part and is situated spaced radially apart from the inner part, and at least one spring mechanism that produces a connection between the at least one inner part and the at least one damper mass.

Rotary oscillation dampers of this kind are known from the prior art and are disclosed, for example, in DE 43 07 583 C1. This document discloses a rotary oscillation damper with a support element and a flywheel ring, which are connected to each other by means of six elastic segments. The segments are composed of rubber and are vulcanized onto an inner circumference surface of the flywheel ring and an outer circumference surface of the support element. Three fastening devices made of rubber are vulcanized onto the outer circumference surface of the support element. A sliding member composed of a hard elastic material is inserted axially into each of the fastening devices. The sliding members have a sliding surface with which they partially rest against the inner circumference surface of the flywheel ring. The sliding members are embodied in the form of a bridge with a bridge arch and two bridge supports. The bridge supports are accommodated in the holding devices and between the bridge supports and the holding devices, an interstice is provided, which is closed when a radial load is exerted on the rotary oscillation damper. In addition, a lubricant conduit is embodied between the bridge arch and the holding devices.

The document DE 44 30 036 C1 describes a rotary oscillation damper with sliding blocks, which are each situated in a respective interstice between a pair of holding devices and have a filling.

The document EP 2 187 088 B1 also discloses a rotary oscillation damper with an inner ring and a mass ring that is coaxial to the inner ring. The inner ring and the coaxial mass ring are connected to each other by a plurality of spring elements composed of elastic material. Sliding members are also provided, which rest against an inner circumference surface of the mass ring and are movable relative to it. The sliding members are associated with a damping element, which is composed of an elastically deformable material and is situated between the inner ring and the sliding members.

The rotary oscillation dampers known from the prior art have been extensively optimized in terms of their performance and service life. There is nevertheless a need for rotary oscillation dampers that can absorb high oscillation amplitudes and have a further extended longer service life.

One object of the present invention is to create a rotary oscillation damper, which, in comparison to the prior art, has an increased performance and also an extended service life.

This object is attained by a rotary oscillation damper having the features of claim 1.

Other embodiments of the invention are disclosed in the dependent claims.

In the oscillation damper according to the invention, the at least one inner part and the at least one damper mass can be connected by means of the at least one spring mechanism in such a way that the at least one spring mechanism has a predetermined radial prestressing.

The radial prestressing of the spring mechanism extends the service life of the rotary oscillation damper due to the fact that the at least one radially prestressed spring mechanism is able to withstand higher loads over a longer period of time. The at least one spring mechanism also determines the maximum relative rotation and maximum oscillation amplitude between the at least one inner part and the at least one damper mass. Compared to the prior art without radially prestressed spring mechanisms, the radial prestressing results in higher oscillation amplitudes and greater relative rotations between the inner part and the damper mass and results in an extended service life since the higher oscillation amplitudes can be absorbed over a longer period of time.

The spring mechanism can be made of an elastic material such as an elastomer or rubber.

According to one embodiment of the invention, the at least one spring mechanism has at least one spring element extending in the radial direction. The spring mechanism can correspondingly be embodied so that the at least one spring element extending in the radial direction has the predetermined radial prestressing and produces a connection between the at least one inner part and the at least one damper mass.

According to one embodiment of the invention, the at least one spring mechanism can have at least one coupling device. The at least one coupling device serves to couple the at least one spring mechanism to the at least one inner part and/or the at least one damper mass. The at least one coupling device can produce a connection between the at least one spring mechanism and the damper mass. In this case, the at least one spring mechanism can, for example, be affixed directly to the at least one inner part. On the other hand, the at least one coupling device can be embodied so that it connects the at least one spring mechanism to both the at least one damper mass and the at least one inner part. In addition, the at least one coupling device is connected to the at least one spring element, i.e. the coupling device can directly adjoin a spring element extending in the radial direction and can produce a connection with the damper mass or the inner part.

According to a modification of the invention, the coupling device can be embodied so that the at least one coupling device connects adjacent spring elements. The rotary oscillation damper can be provided with a plurality of spring elements extending in the radial direction, which can be arranged offset from one another by a predetermined angle around the outer circumference of the inner part of the oscillation damper. The coupling device here can connect adjacent spring elements, for example two spring elements, to each other. The coupling device can be embodied as plate-shaped and can have a curvature that is adapted to the radius of the inner circumference surface of the damper mass.

The at least one spring mechanism can have at least one sliding element. The at least one sliding element or the at least one sliding member serves to support the damper mass in the radial direction. In other words, the structural embodiment of the at least one sliding element can be used to increase the rigidity of the oscillation damper in the radial direction and to specifically set the oscillation damper to a desired frequency range to be compensated. The at least one sliding element can be provided on the at least one coupling device. The at least one sliding element or the at least one sliding member can be integrated into the coupling device or be embodied of one piece with the coupling device. The at least one sliding element can also be fastened to the at least one coupling device. The at least one coupling device and the at least one sliding element can be made of different materials. For example, the at least one sliding element can be composed of a harder plastic than the rest of the coupling device. If adjacent spring elements are connected to each other by means of the at least one coupling device, then the at least one sliding element can be provided in the region of the coupling device that extends between the two spring elements. In general, the at least one sliding element is embodied so that when a relative rotation occurs, it slides on a predetermined sliding surface either on the damper mass or on the at least one inner part.

According to one embodiment of the invention, the at least one sliding element can have at least one chamber. The at least one chamber can be embodied in a surface of the sliding element that is oriented away from the sliding surface. When the at least one spring mechanism is manufactured, the at least one chamber can be filled with an elastic material such as an elastomer or the like and can fasten the at least one sliding element to the spring mechanism.

According to a modification of the invention, at least one stop element can be provided. The at least one stop element can limit a relative rotation between the at least one damper mass and the at least one inner part, i.e. can limit the amplitude of torsional rotating motions. The at least one stop element can cooperate with the at least one sliding element to limit the relative rotation or amplitude. In addition, the at least one spring mechanism can be equipped with the at least one stop element. It is also conceivable, though, for the at least one stop element to be embodied on the damper mass and/or the inner part or more specifically, formed onto these components.

According to one embodiment of the invention, the spring mechanism can be vulcanized onto the at least one inner part or the at least one damper mass. In this case, the at least one spring mechanism is connected by means of the at least one coupling device to the inner part that is not vulcanized to it or to the damper mass that is not vulcanized to it. If one assumes that the at least one spring mechanism is vulcanized onto the inner part, then the at least one spring mechanism is connected to the damper mass by means of the at least one coupling device. It is, however, also possible to vulcanize the at least one spring mechanism onto the damper mass and to connect it to the at least one inner part by means of the coupling device. The coupling device can, for example, produce a connection to the damper mass and/or the inner part by means of a form-fitting engagement.

Alternatively, though, it is also conceivable for the at least one coupling device to have at least one coupling element for coupling the at least one spring mechanism to the at least one damper mass and at least one additional coupling element for coupling the at least one spring mechanism to the inner part. In other words, according to this embodiment, the at least one spring mechanism has one coupling element for connecting the spring mechanism to the damper mass and one coupling element for connecting it to the inner part. The damper mass, the inner part, and the spring mechanism or its coupling device in this case can be embodied so that the spring mechanism is respectively connected to both the damper mass and the inner part by means of a form-fitting engagement.

According to another embodiment of the invention, the at least one spring mechanism can be a modular assembly, which can be connected to the at least one damper mass and the at least one inner part with prestressing, in particular radial prestressing. The assembly composed of the at least one spring mechanism can be vulcanized separately. The at least one spring mechanism can be affixed to the at least one damper mass and the at least one inner part. The at least one spring mechanism can be affixed to the at least one inner part and/or the at least one damper mass by means of a form-fitting engagement or by means of a nonpositive, frictional engagement.

The at least one sliding element can be embodied of one piece with the at least one coupling device. For example, the at least one coupling device can be embodied as plate-shaped and can have at least one integrally embodied sliding element. In addition, the at least one coupling device can have a connecting piece on which at least one sliding element is integrally embodied.

The at least one spring mechanism can have at least two sliding elements whose sliding surfaces slide on each other. In addition, one of the sliding elements can be embodied so that it connects two coupling elements of a coupling device.

According to one embodiment, the at least one sliding element can be connected to the damping element by means of at least one connecting section and can have at least one sliding surface section, which can extend in the circumference direction of the oscillation damper starting from the at least one connecting section and can set a predetermined setpoint air gap relative to the at least one sliding surface. Such a sliding element can set a setpoint air gap between the sliding surface section and the sliding surface of the inner support and/or the mass ring relatively simply since the sliding element, because of its structural embodiment, assumes a setpoint position after the vulcanization of the damping element and with its at least one sliding surface section, sets a setpoint air gap relative to the sliding surface of the mass ring and/or the inner support. In particular, a desired amount of play, i.e. the setpoint air gap between the sliding element and sliding surface, can be set so that it is possible preclude the occurrence of imbalances and a jamming of the oscillation damper during operation of the oscillation damper.

In this connection, it should be noted that according to the invention, the at least one sliding element is embodied so that in the vicinity of the at least one connecting section, the distance of the at least one sliding element from the sliding surface of the mass ring and/or of the inner support is greater than the predetermined setpoint air gap that is set by the at least one sliding surface section. Preferably, the sliding element has a larger cross-section in the vicinity of the at least one sliding surface section than it does in the vicinity of the at least one connecting section. Such a structural embodiment of the sliding element promotes a “springy” behavior of the sliding element, which allows the sliding surface sections to “spring” into a setpoint position after the vulcanization in order to set a predetermined setpoint air gap.

All of the embodiments of the invention have in common the fact that when a connection is produced between the inner part and the damper mass by means of the at least one spring mechanism, this provides the at least one spring mechanism with a predetermined radial prestressing. In order to accomplish this, for example, the spring mechanism can be press-fitted into the damper mass in the axial direction and by means of a form-fitting engagement, can produce a connection between the inner part and the damper mass.

Exemplary embodiments of the invention will be described below with reference to the accompanying figures. In the drawings:

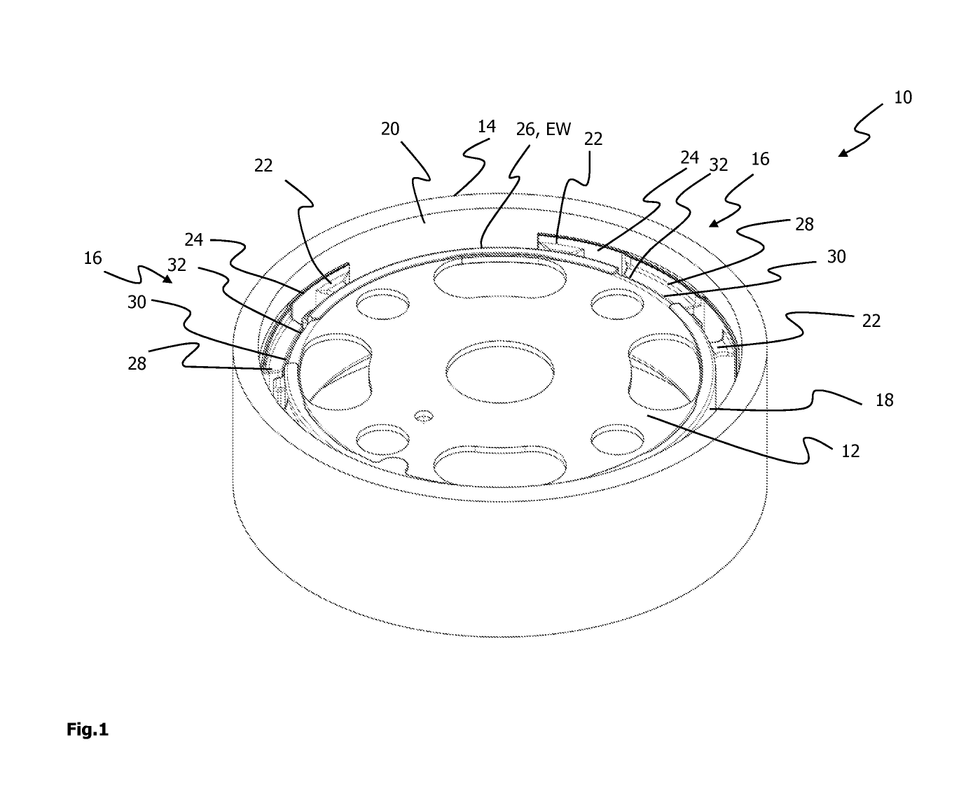

FIG. 1 is a perspective view of a rotary oscillation damper according to a first embodiment of the invention;

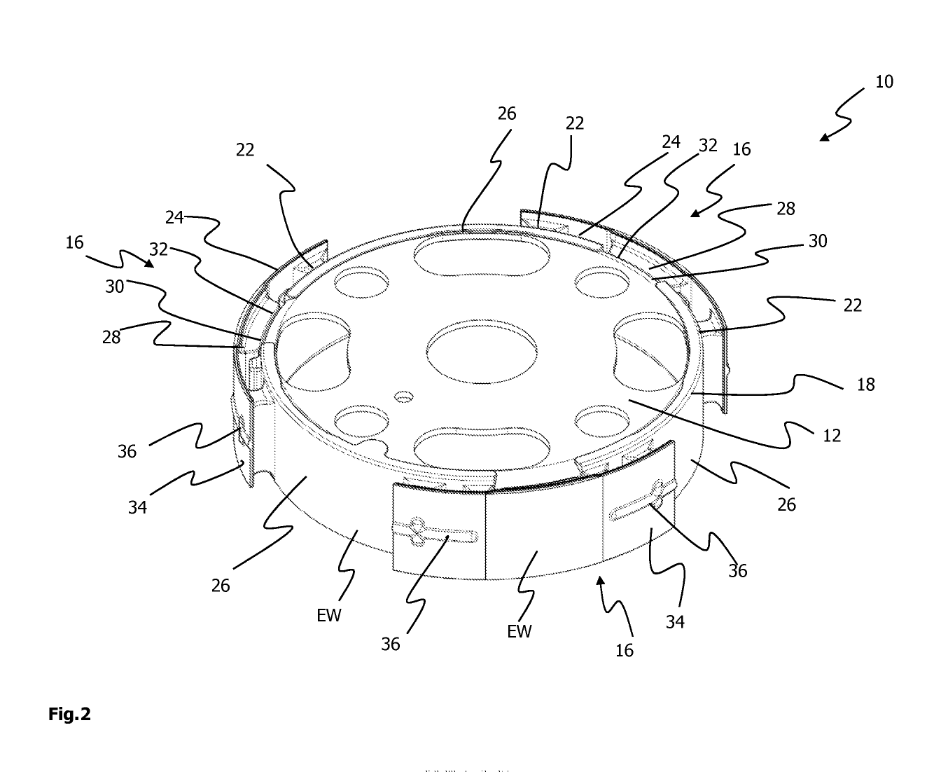

FIG. 2 is a perspective view of an inner part of the rotary oscillation damper according to the first embodiment of the invention with the spring mechanism affixed to it;

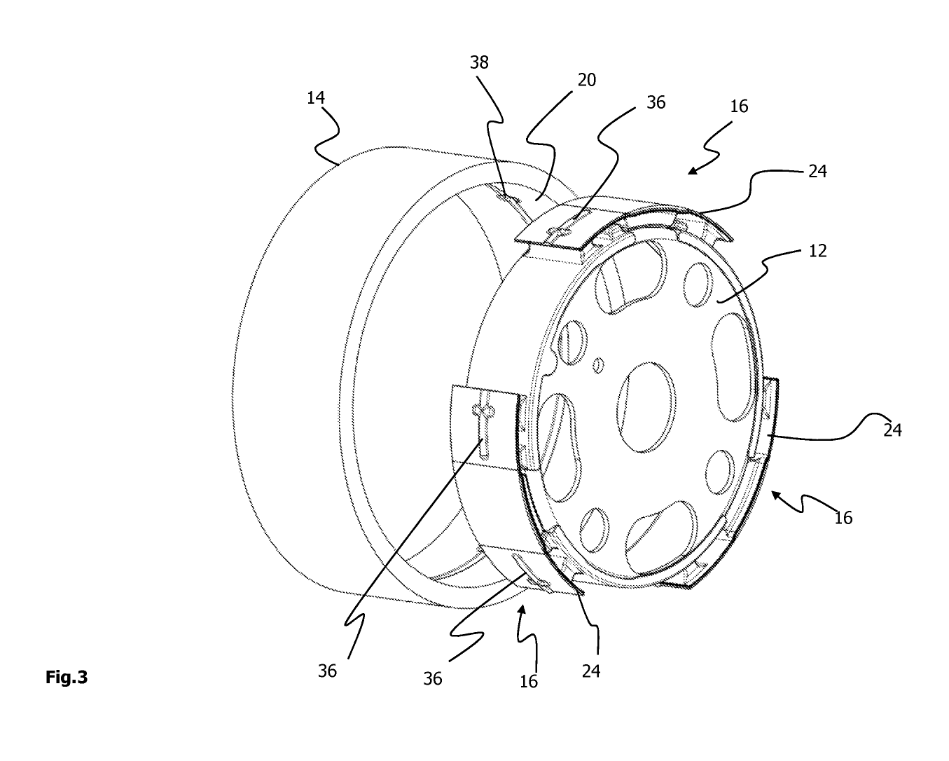

FIG. 3 is a perspective view of the inner part and damper mass of the rotary oscillation damper according to the first embodiment of the invention, with the components separated from one another;

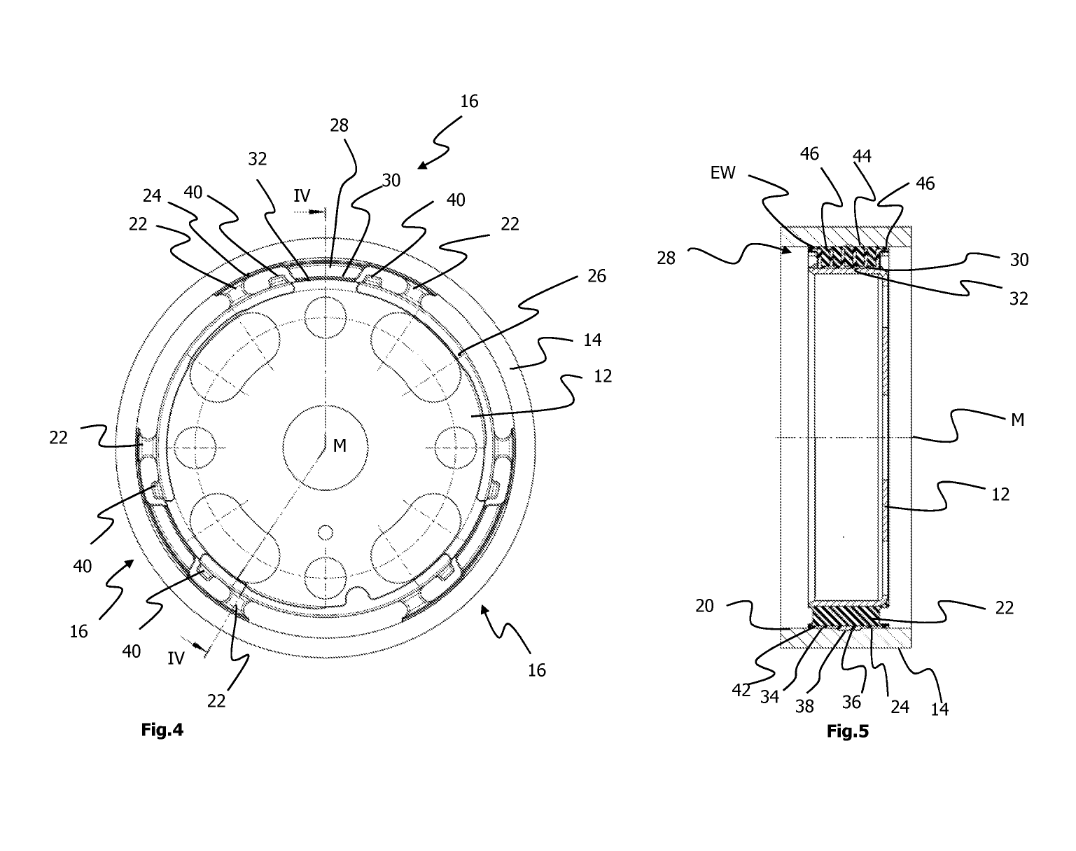

FIG. 4 is a top view of the rotary oscillation damper according to the first embodiment;

FIG. 5 is a sectional view along the cutting line IV-IV shown in FIG. 4;

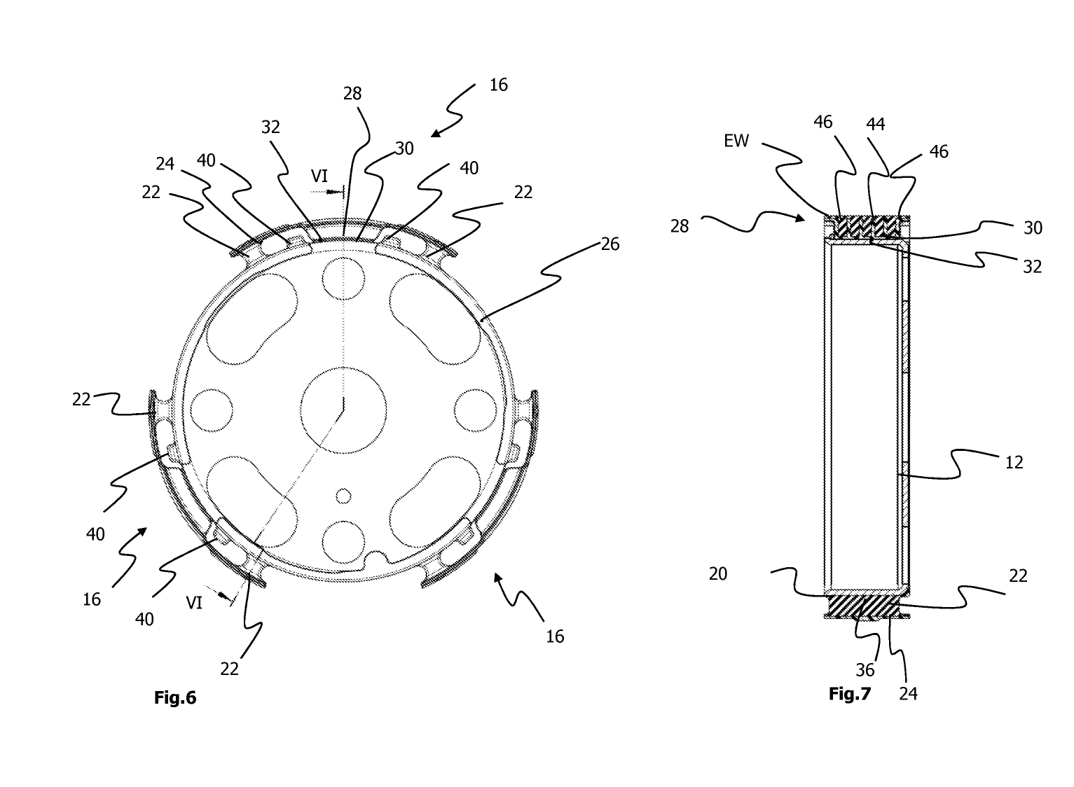

FIG. 6 is a top view of the inner part and spring mechanism of the rotary oscillation damper according to the first embodiment of the invention;

FIG. 7 is a sectional view along the cutting line VI-VI shown in FIG. 6;

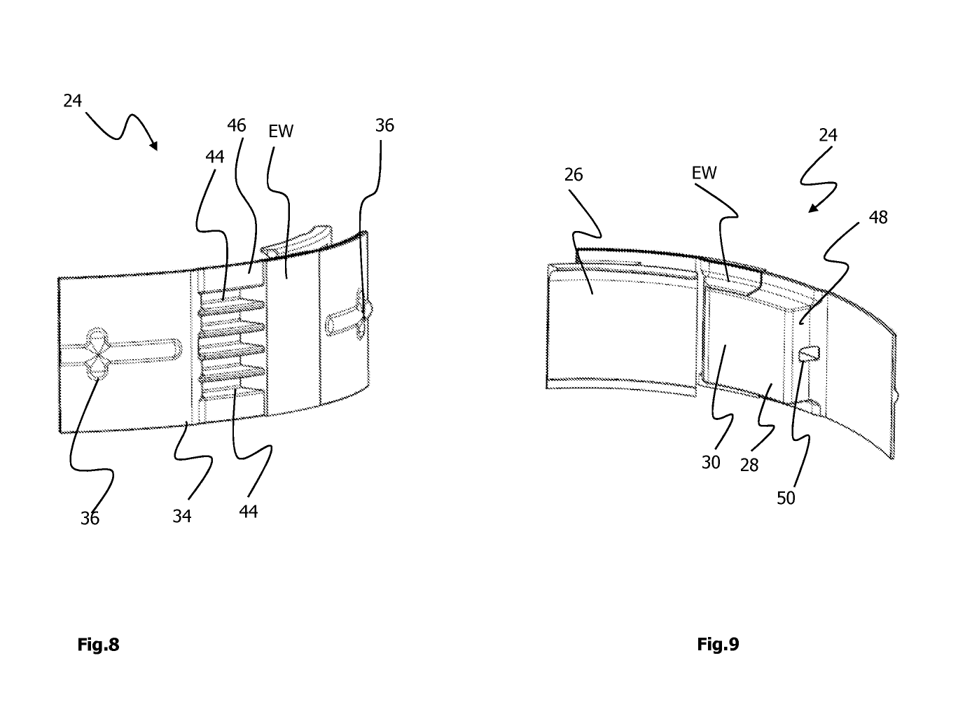

FIGS. 8, 9 show perspective views of the coupling device of the rotary oscillation damper according to the first embodiment of the invention;

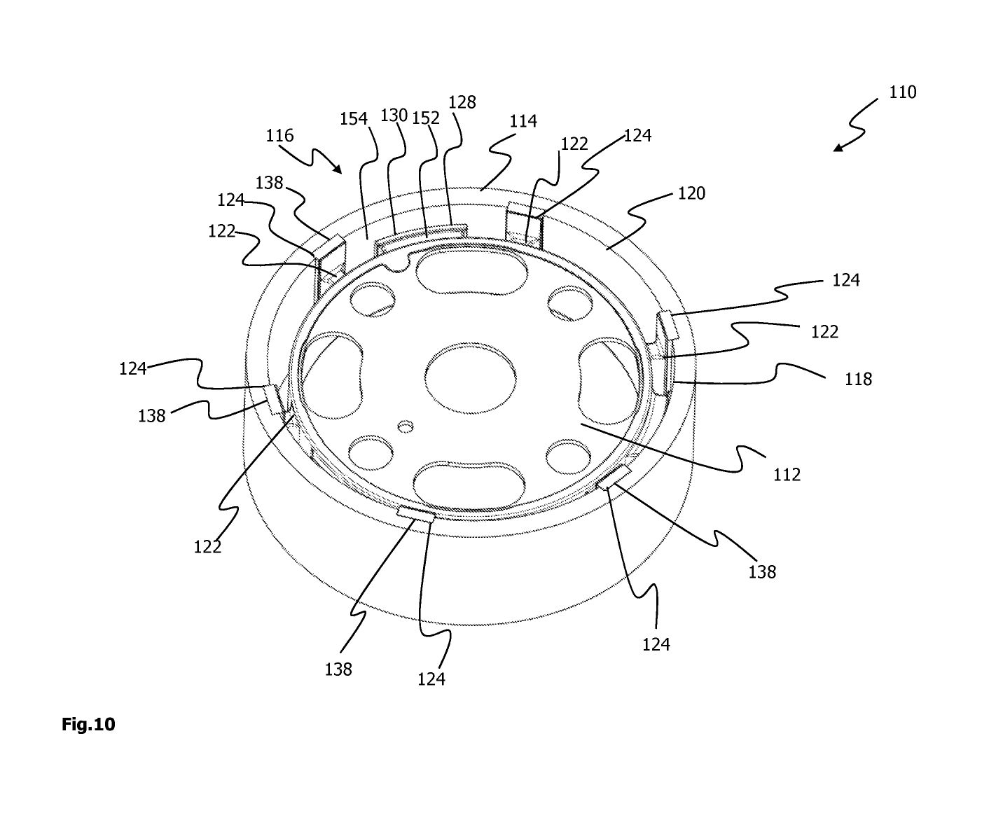

FIG. 10 is a perspective view of a rotary oscillation damper according to a second embodiment of the invention;

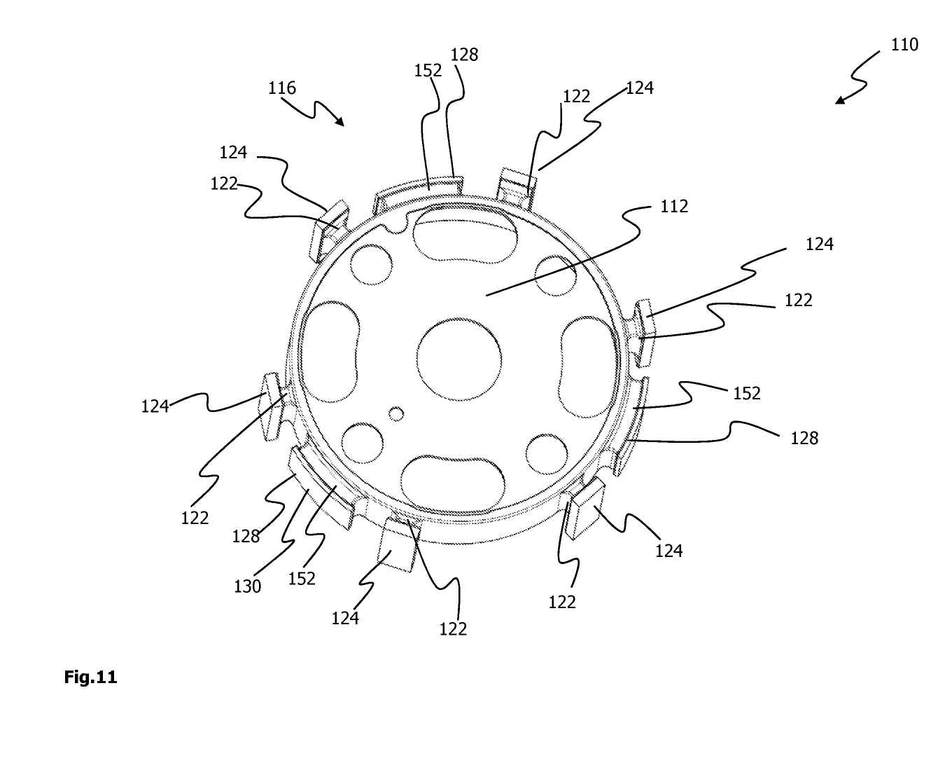

FIG. 11 is a perspective view of an inner part of the rotary oscillation damper according to the second embodiment of the invention with the spring mechanism affixed to it;

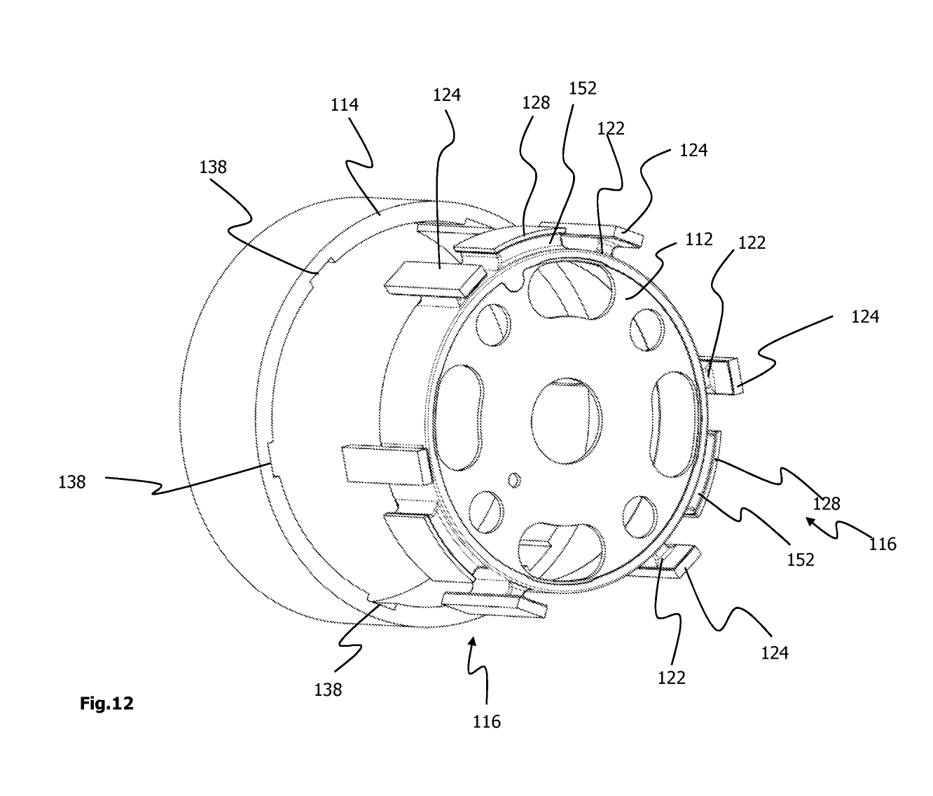

FIG. 12 is a perspective view of the inner part and damper mass of the rotary oscillation damper according to the second embodiment of the invention;

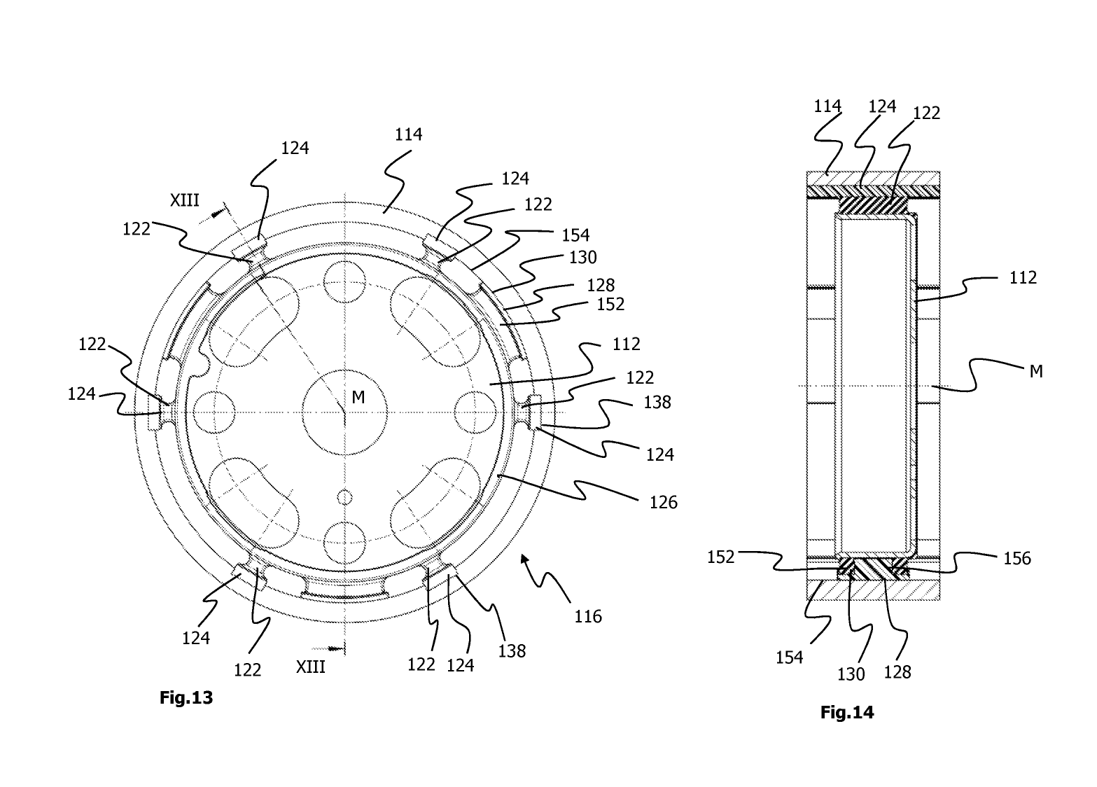

FIG. 13 is a top view of the rotary oscillation damper according to the second embodiment of the invention;

FIG. 14 is a sectional view along the cutting line XIII-XIII shown in FIG. 13;

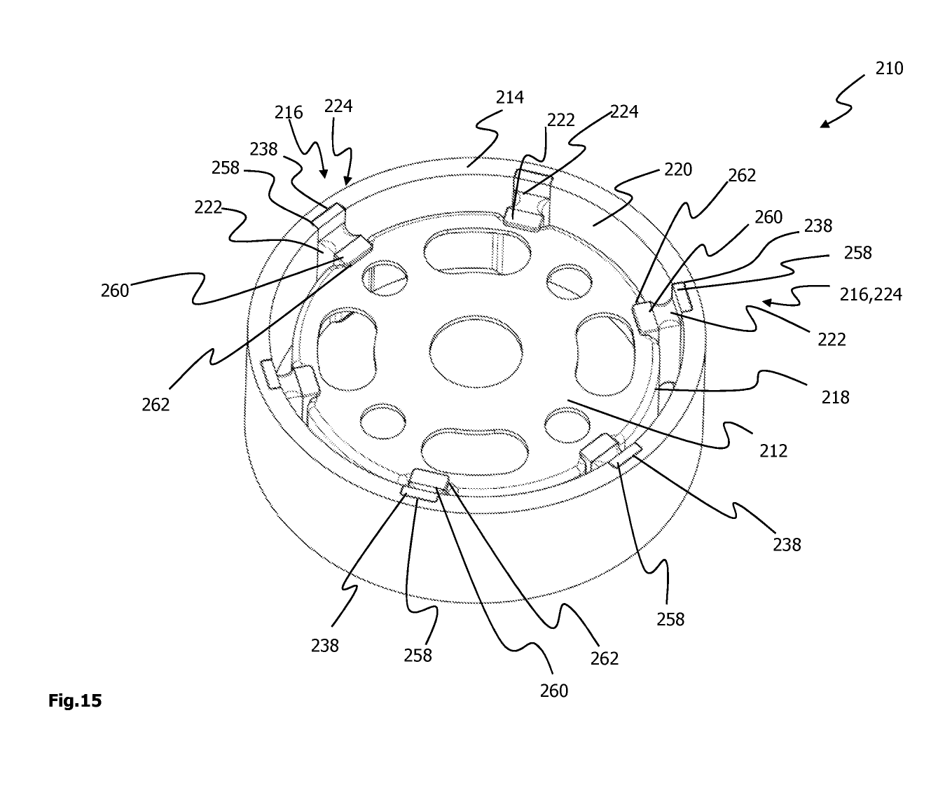

FIG. 15 is a perspective view of a rotary oscillation damper according to a third embodiment of the invention;

FIG. 16 is a perspective view of an inner part and a spring mechanism of the rotary oscillation damper according to the third embodiment of the invention;

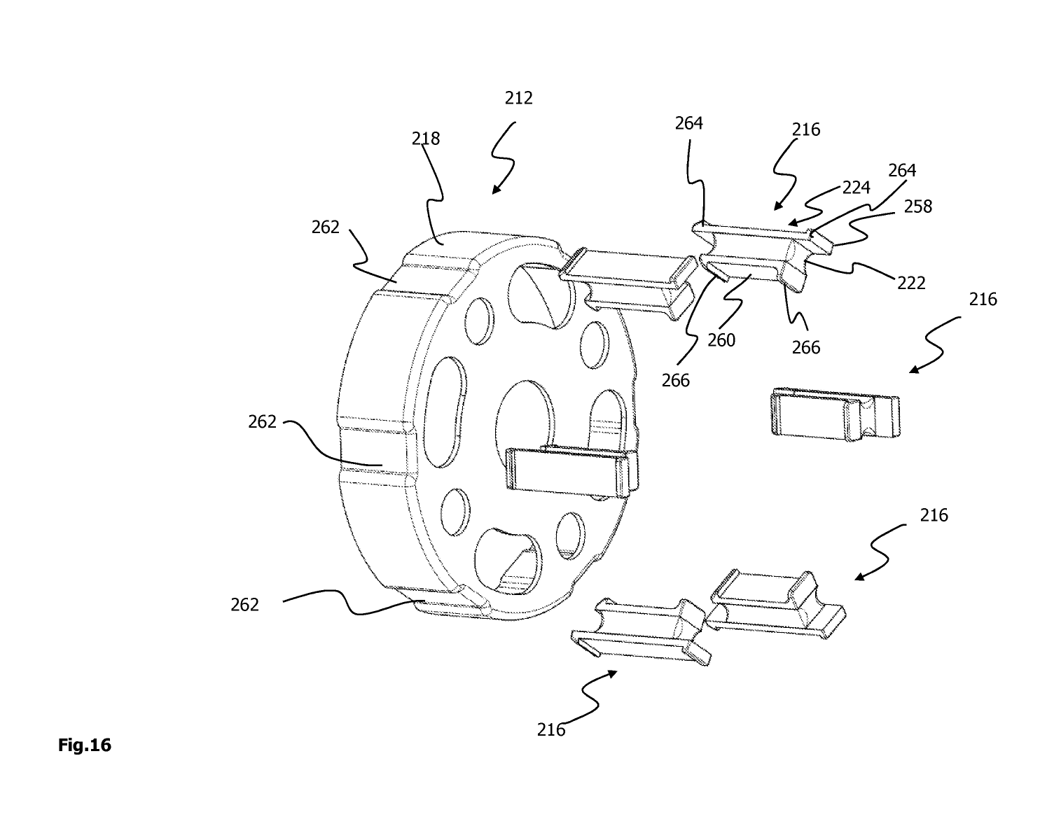

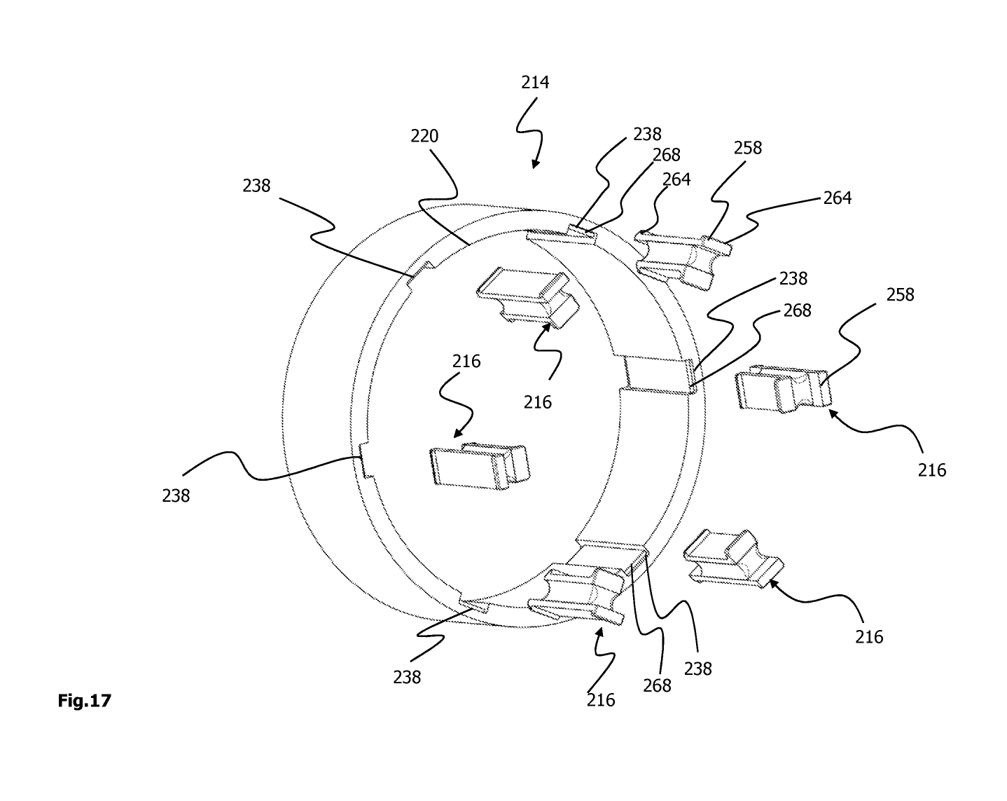

FIG. 17 is a perspective view of a damper mass and the spring mechanism of the rotary oscillation damper according to the third embodiment of the invention;

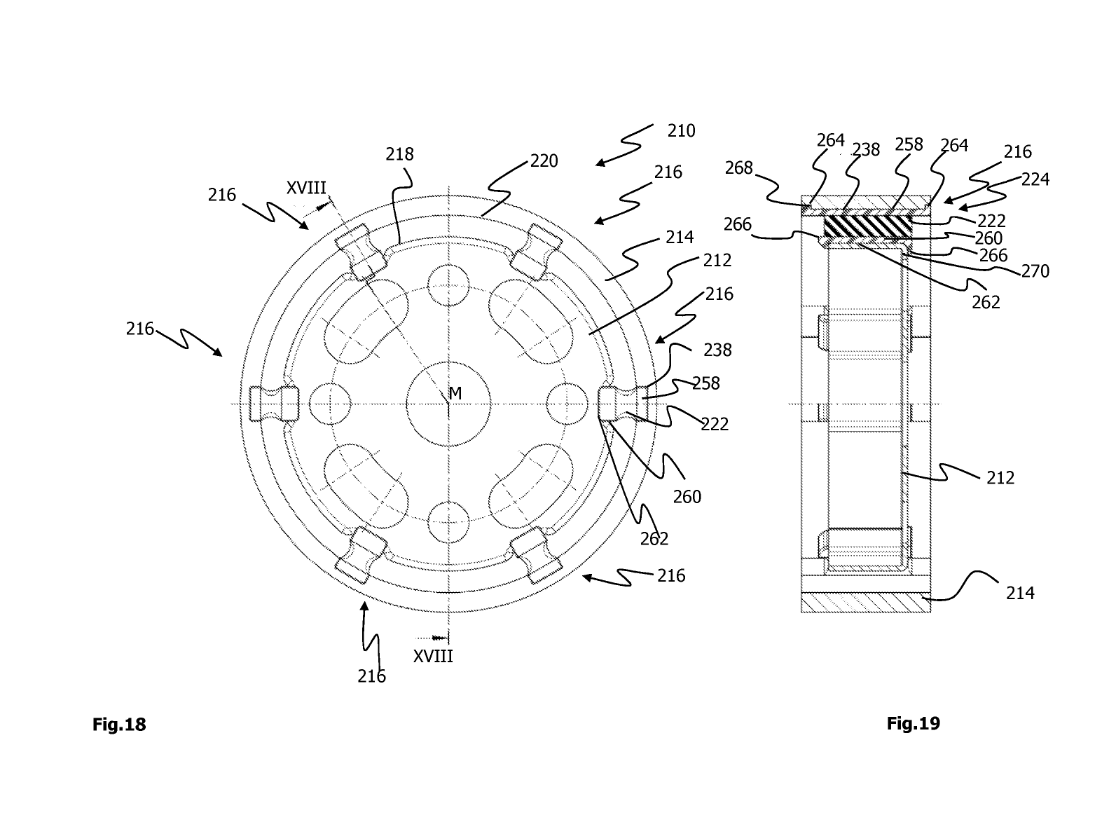

FIG. 18 is a top view of the rotary oscillation damper according to the third embodiment of the invention;

FIG. 19 is a sectional view along the cutting line XVIII-XVIII shown in FIG. 18;

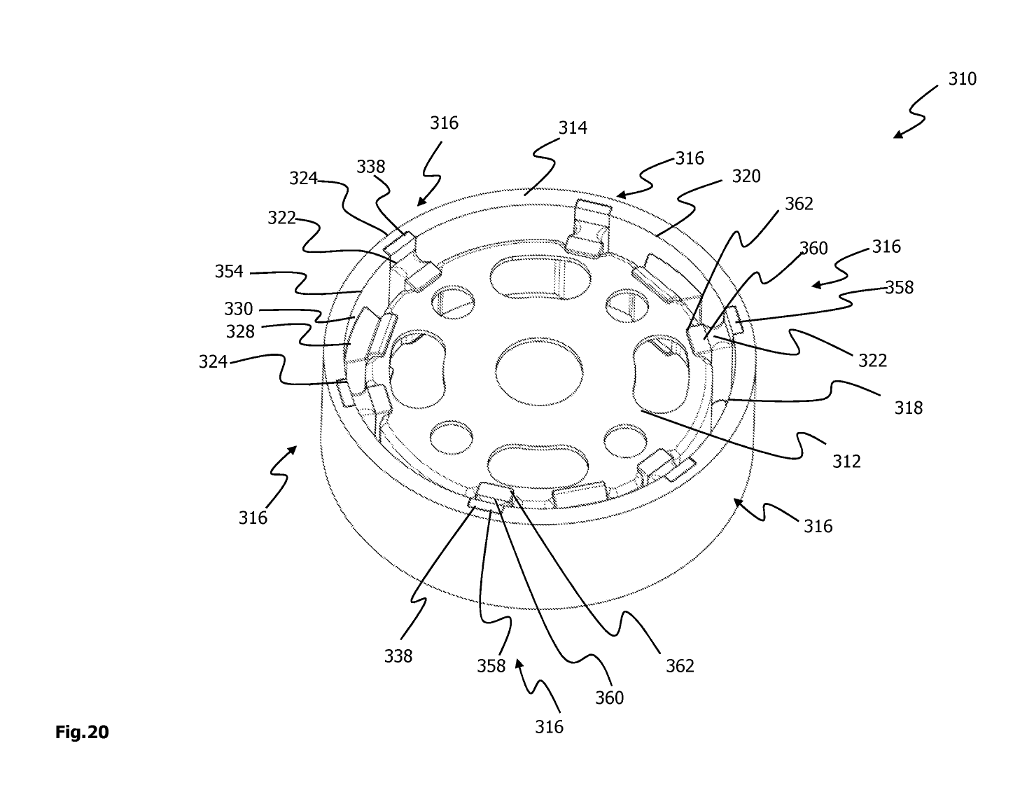

FIG. 20 is a perspective view of a rotary oscillation damper according to a fourth embodiment of the invention;

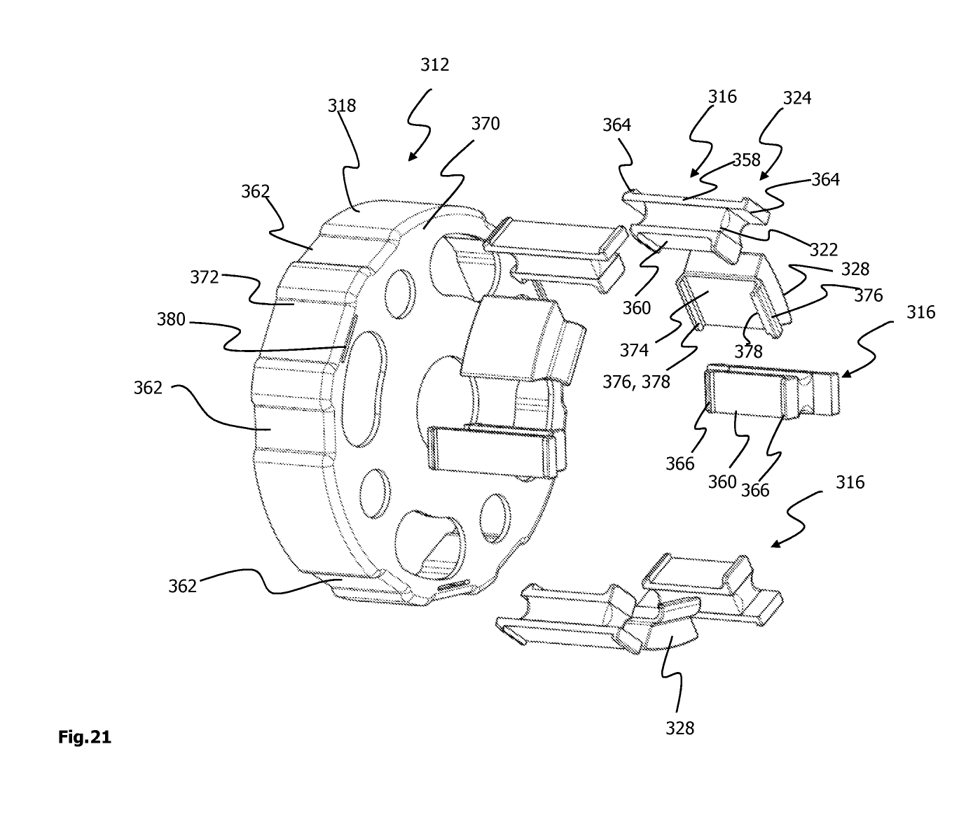

FIG. 21 is a perspective view of an inner part and a spring mechanism of the rotary oscillation damper according to the fourth embodiment of the invention;

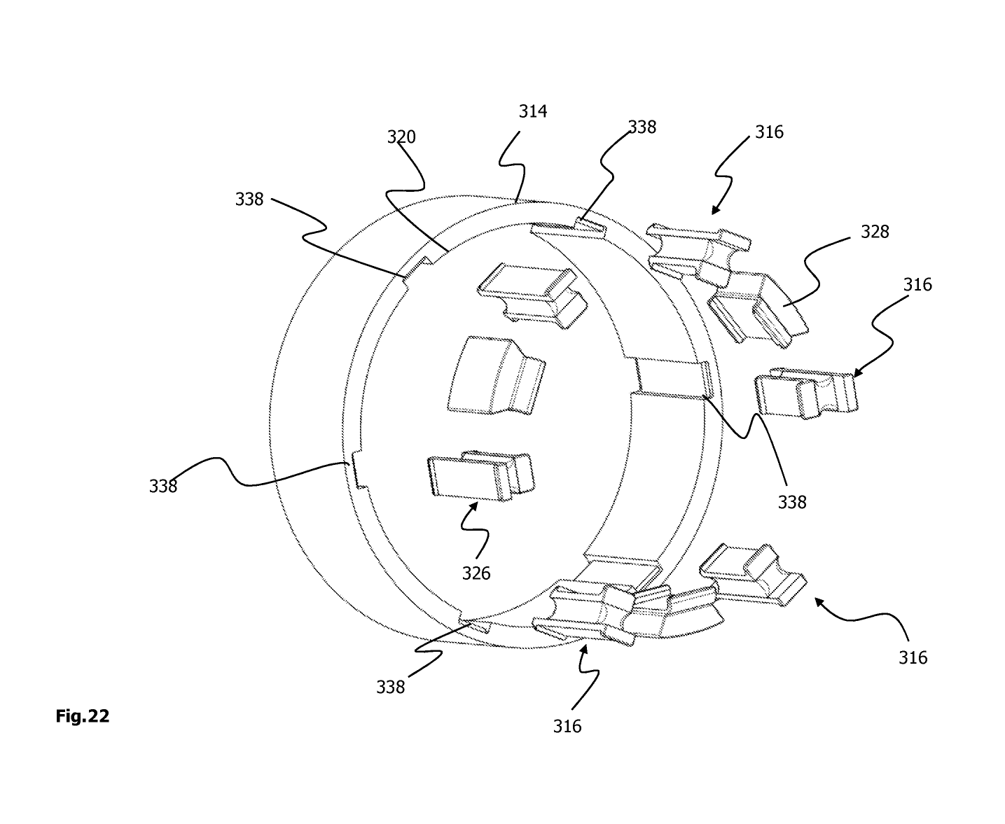

FIG. 22 is a perspective view of a damper mass and the spring mechanism of the rotary oscillation damper according to the fourth embodiment of the invention;

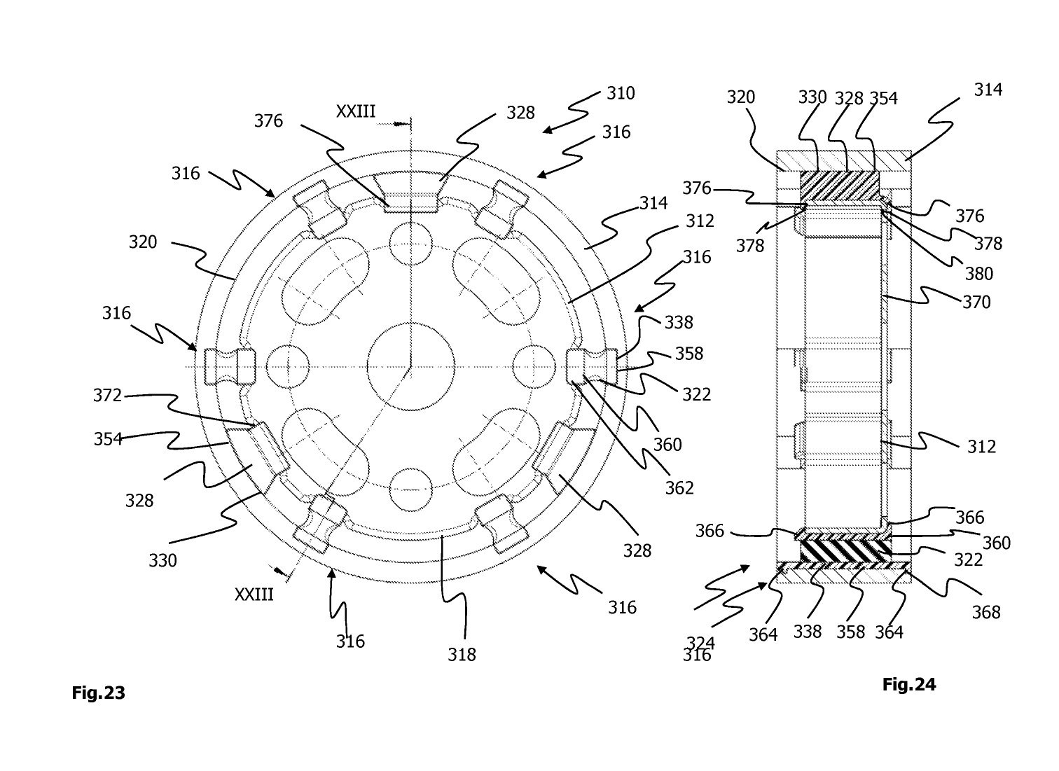

FIG. 23 is a top view of the rotary oscillation damper according to the fourth embodiment of the invention;

FIG. 24 is a sectional view along the cutting line XXIII-XXIII shown in FIG. 23;

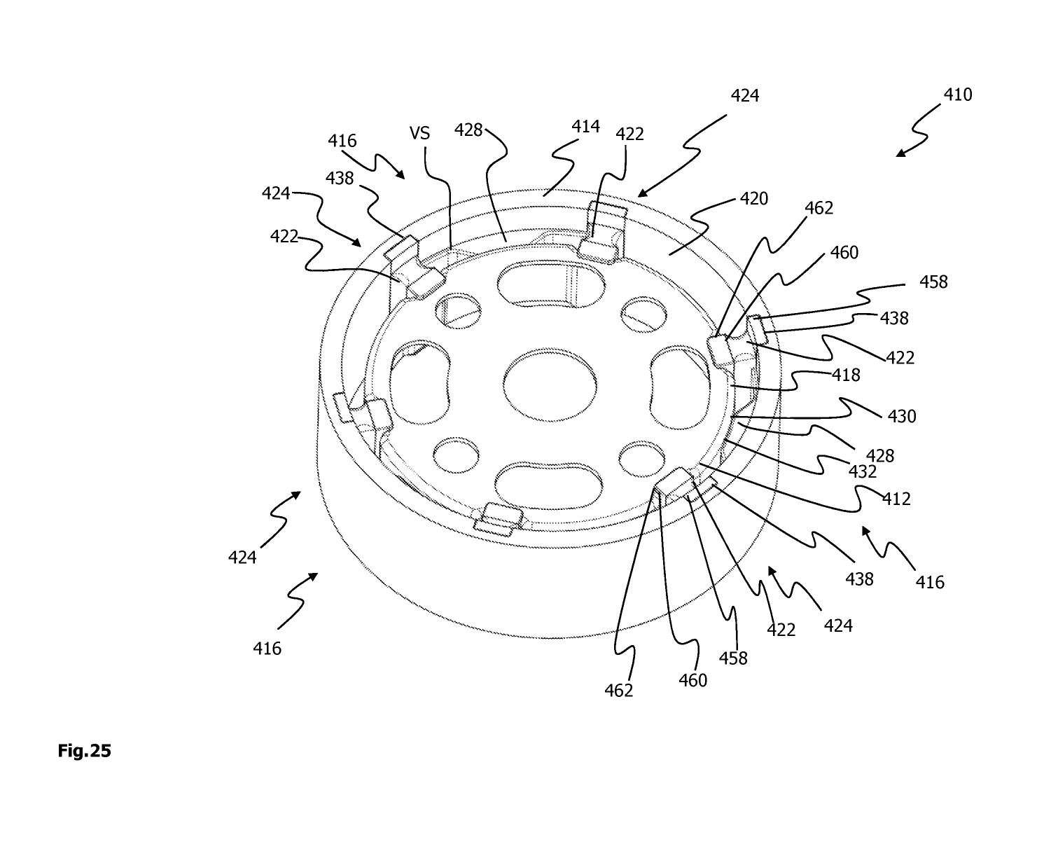

FIG. 25 is a perspective view of a rotary oscillation damper according to a fifth embodiment of the invention;

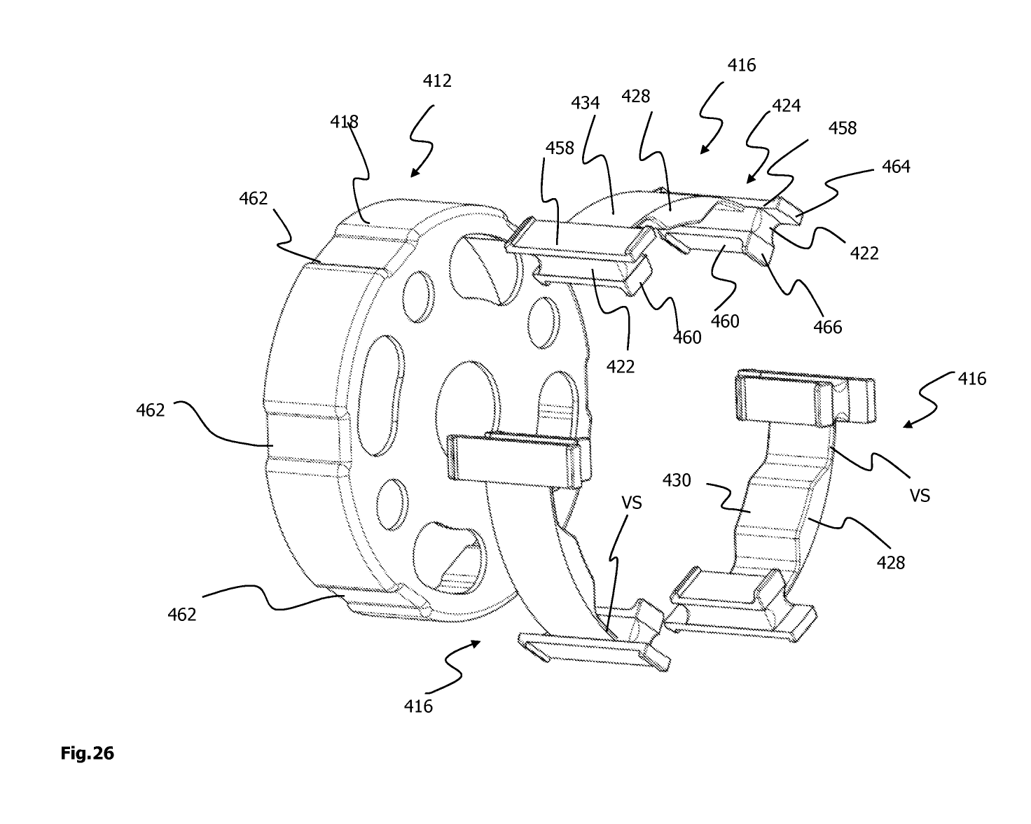

FIG. 26 is a perspective view of an inner part and a spring mechanism of the rotary oscillation damper according to the fifth embodiment of the invention;

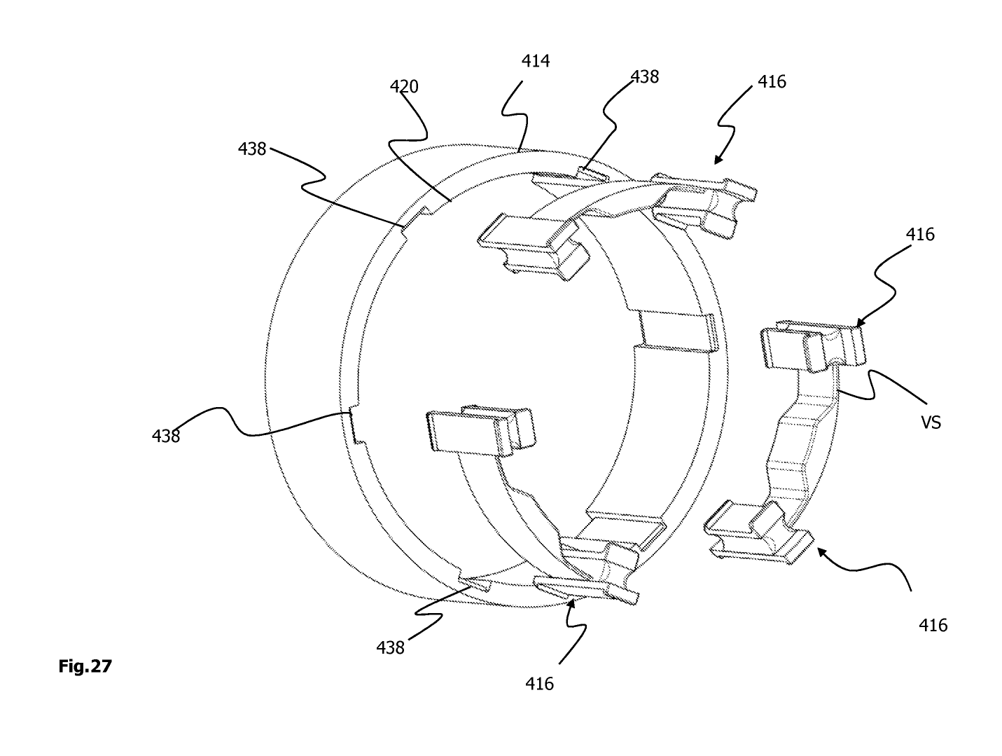

FIG. 27 is a perspective view of a damper mass and the spring mechanism of the rotary oscillation damper according to the fifth embodiment of the invention;

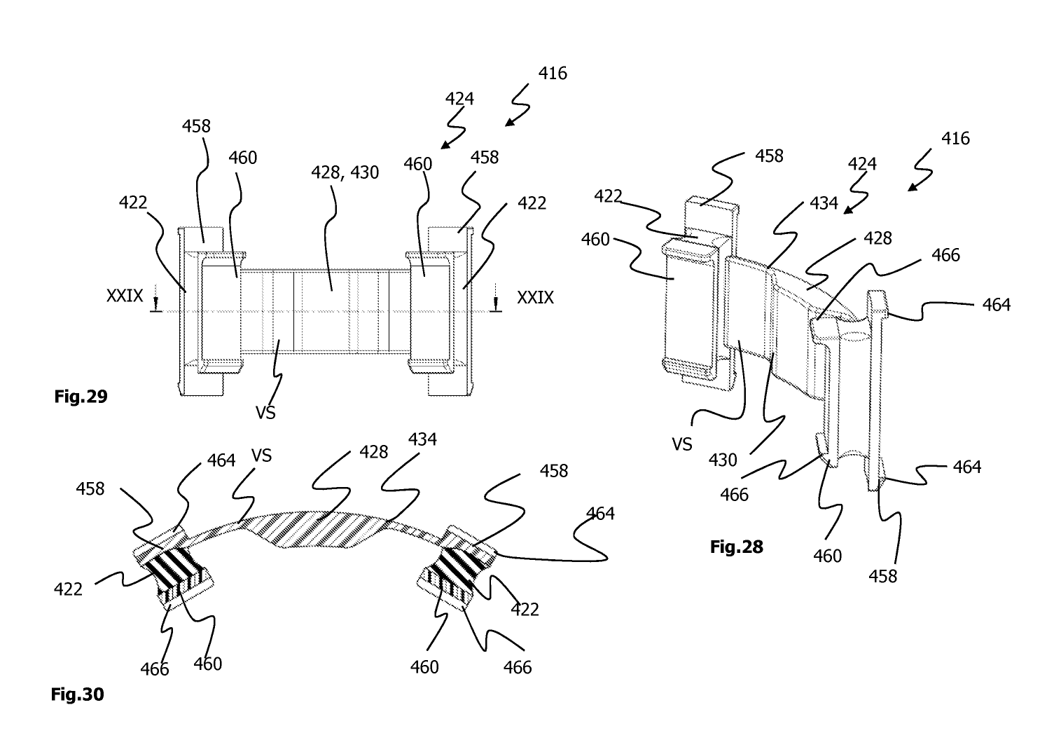

FIGS. 28-30 show views of the spring mechanism of the rotary oscillation damper according to the fifth embodiment of the invention;

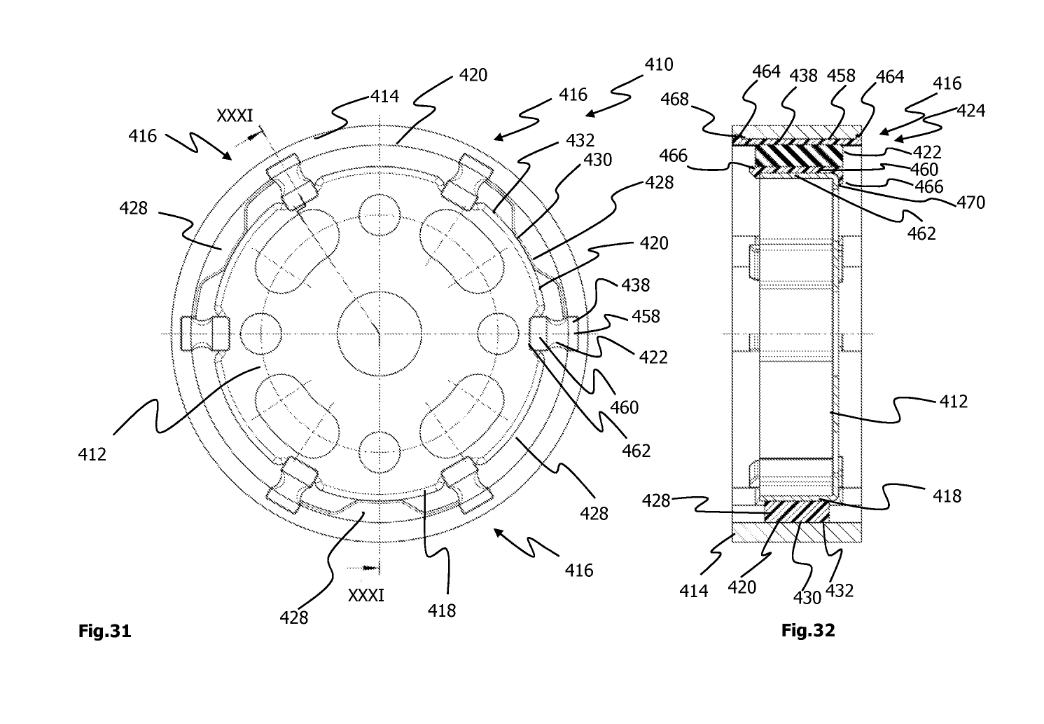

FIG. 31 is a top view of the rotary oscillation damper according to the fifth embodiment of the invention;

FIG. 32 is a sectional view along the cutting line XXXI-XXXI shown in FIG. 31;

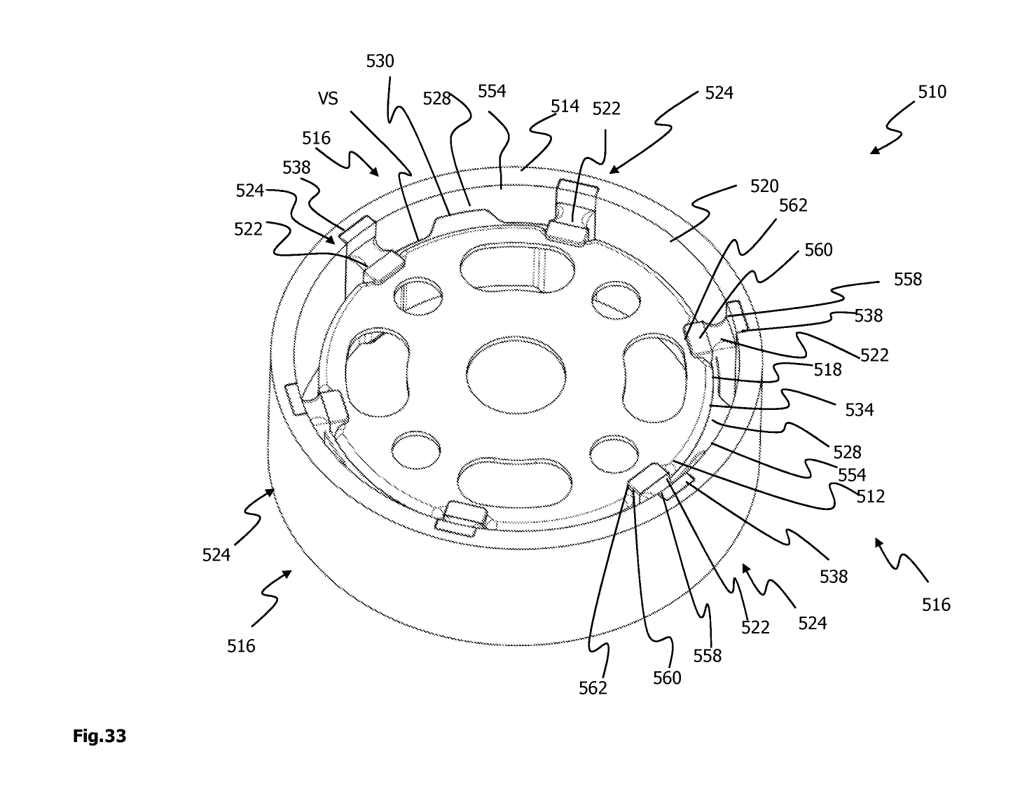

FIG. 33 is a perspective view of a rotary oscillation damper according to a sixth embodiment of the invention;

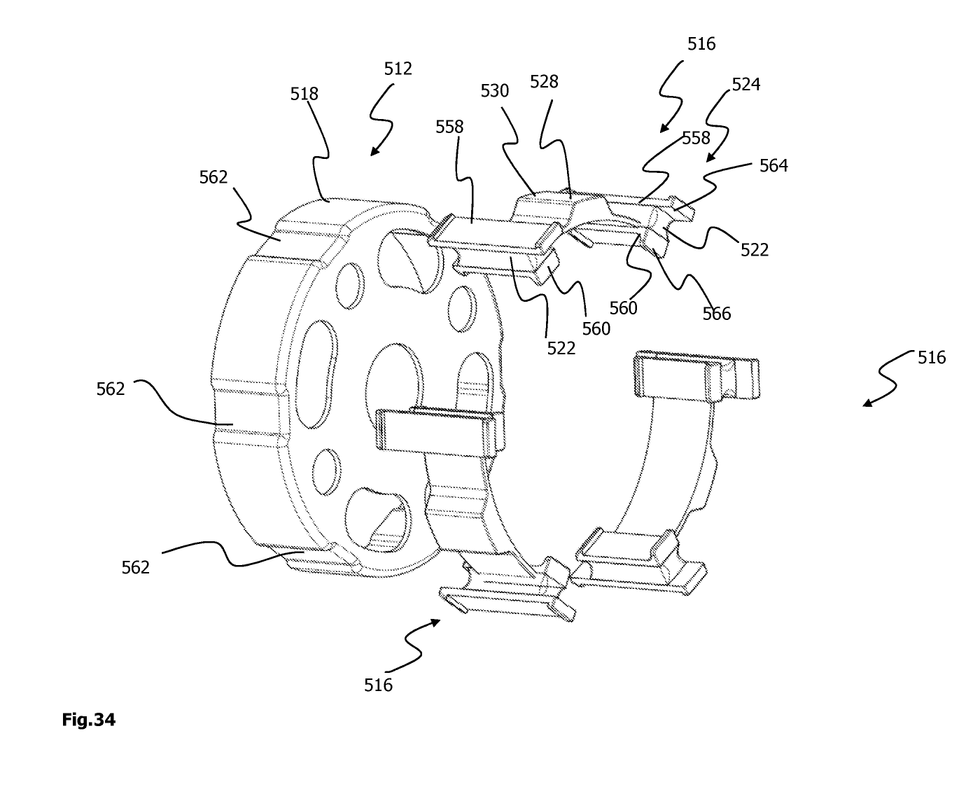

FIG. 34 is a perspective view of an inner part and a spring mechanism of the rotary oscillation damper according to the sixth embodiment of the invention;

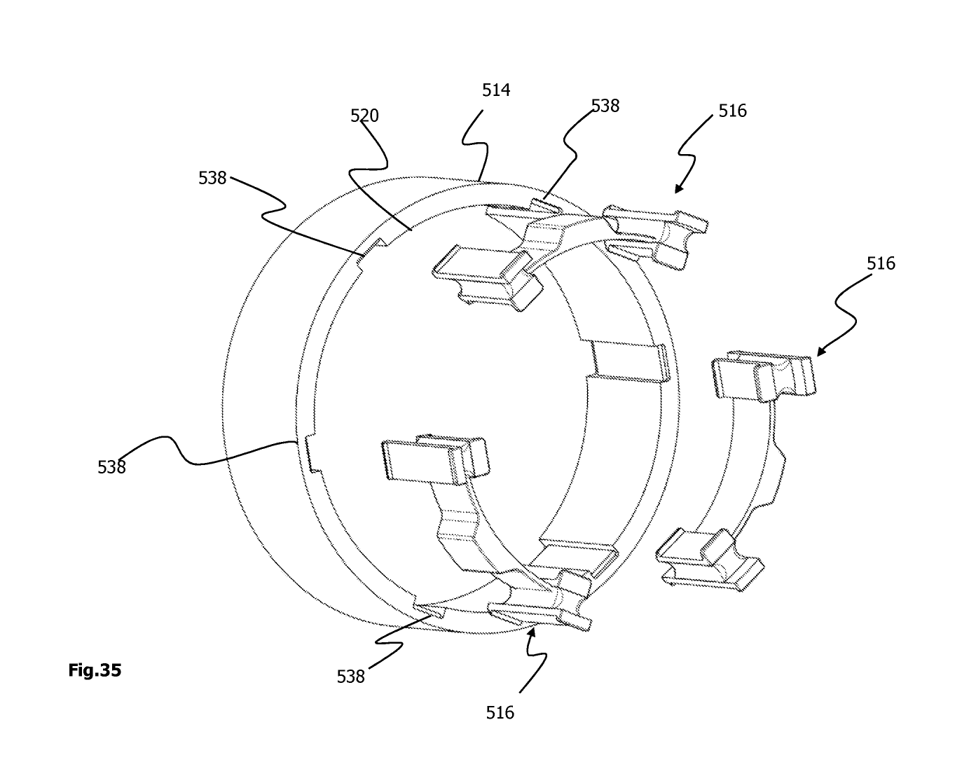

FIG. 35 is a perspective view of a damper mass and the spring mechanism of the rotary oscillation damper according to the sixth embodiment of the invention;

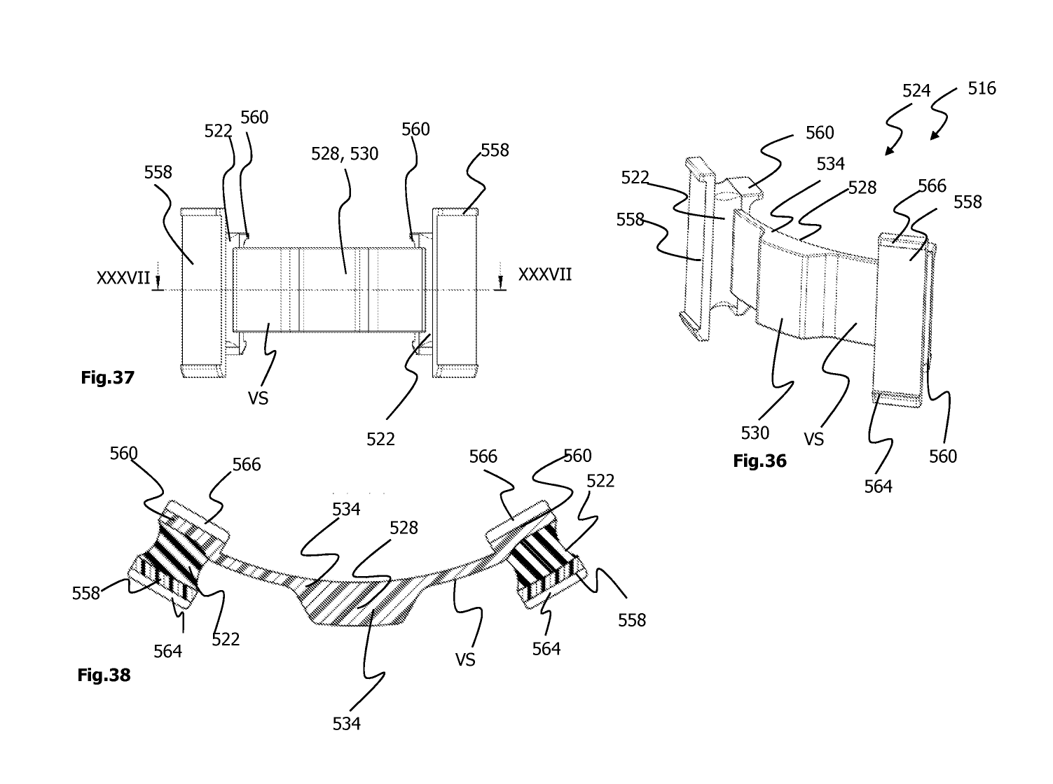

FIGS. 36-38 show views of the spring mechanism of the rotary oscillation damper according to the sixth embodiment of the invention;

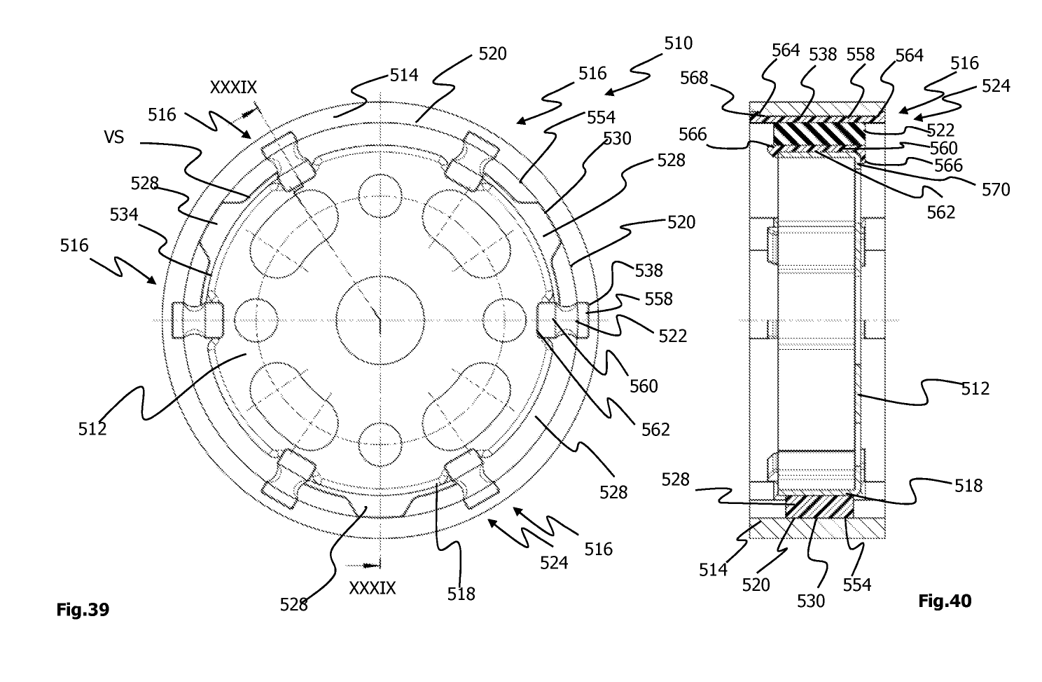

FIG. 39 is a top view of the rotary oscillation damper according to the sixth embodiment of the invention;

FIG. 40 is a sectional view along the cutting line XXXIX-XXXIX shown in FIG. 39;

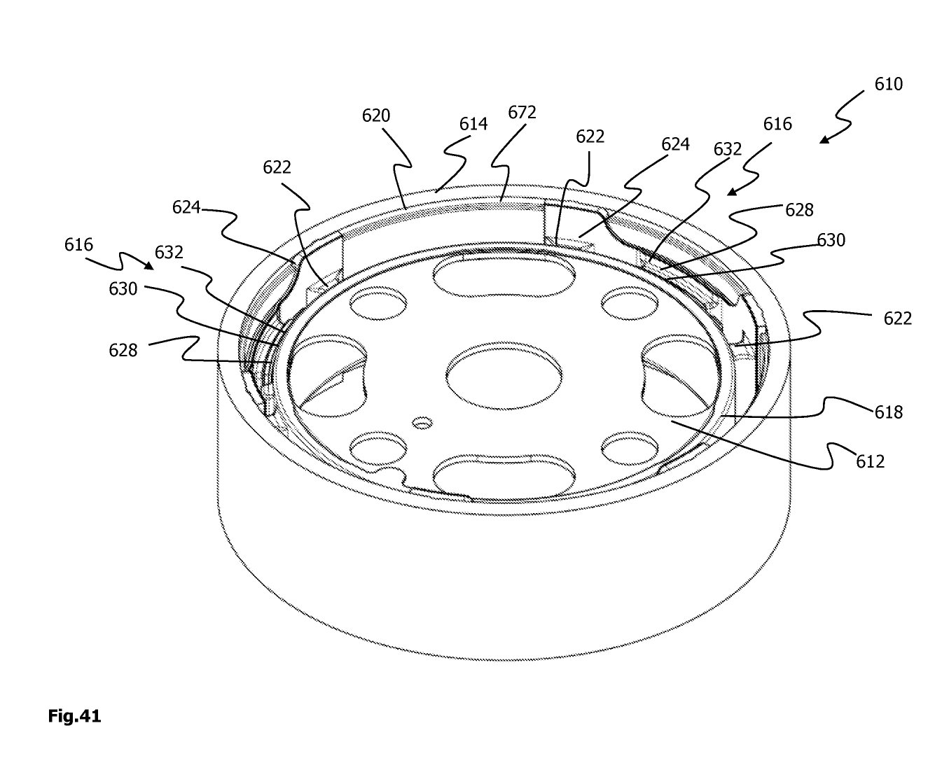

FIG. 41 is a perspective view of a rotary oscillation damper according to a seventh embodiment of the invention;

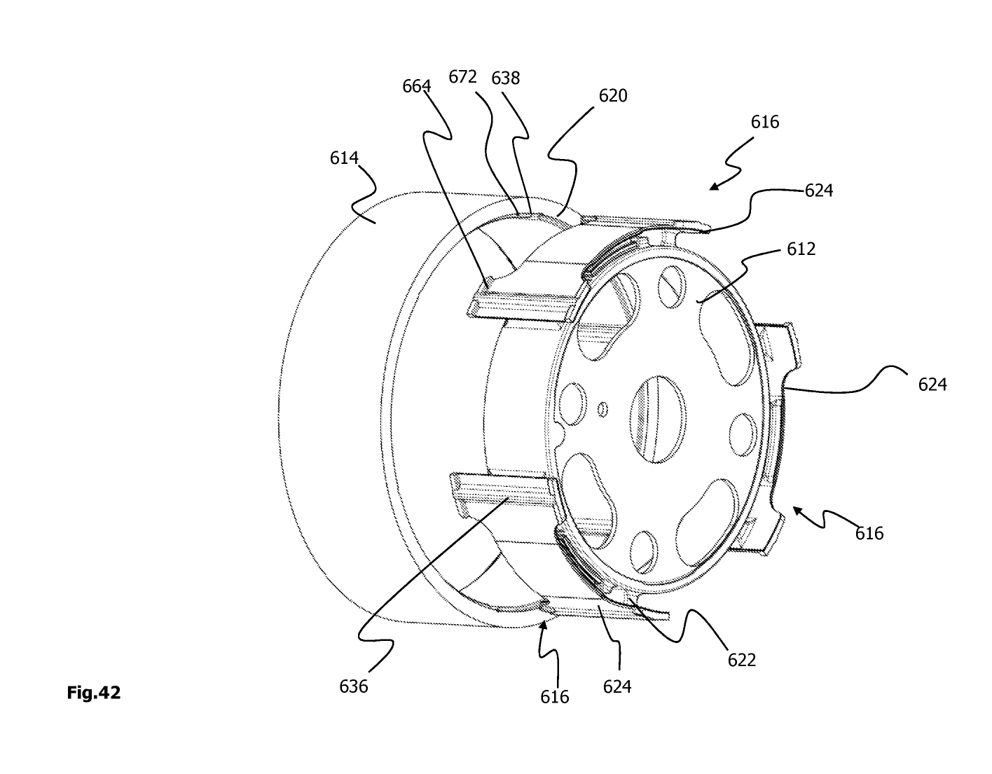

FIG. 42 is a perspective view of an inner part with a spring mechanism and the damper mass of the rotary oscillation damper according to the seventh embodiment of the invention;

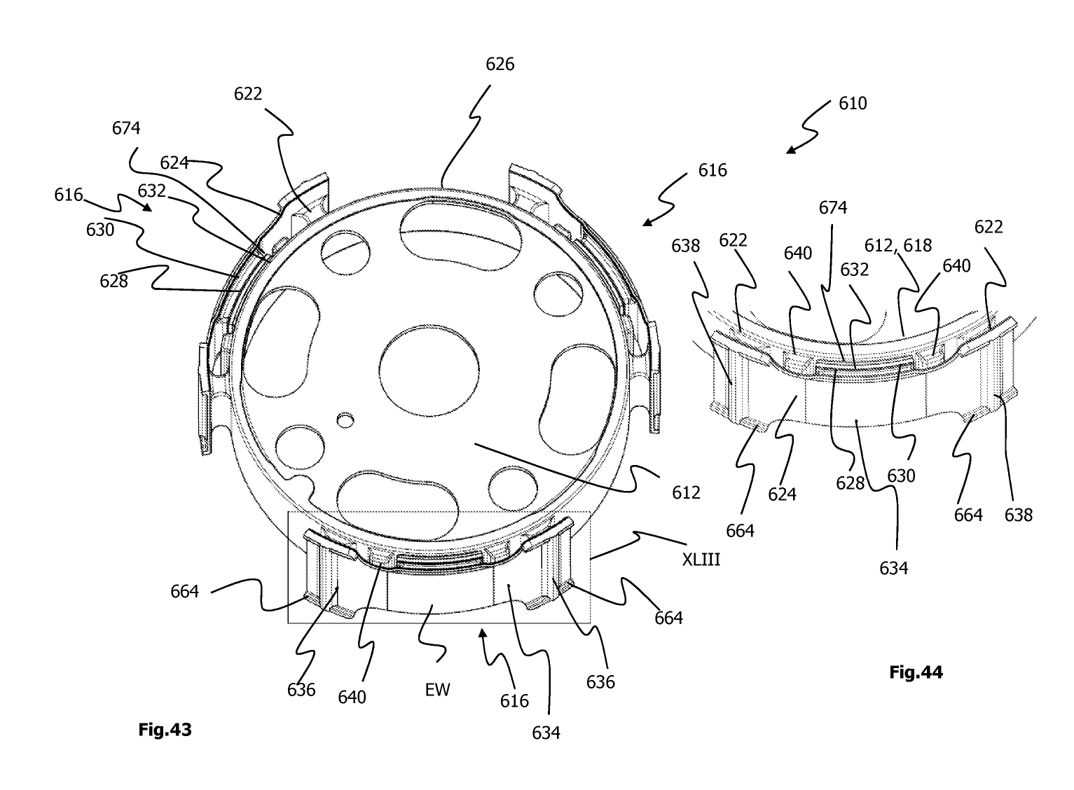

FIG. 43 is a perspective view of the inner part and spring mechanism of the rotary oscillation damper according to the seventh embodiment of the invention;

FIG. 44 is an enlarged view of the detail XLIII from FIG. 43;

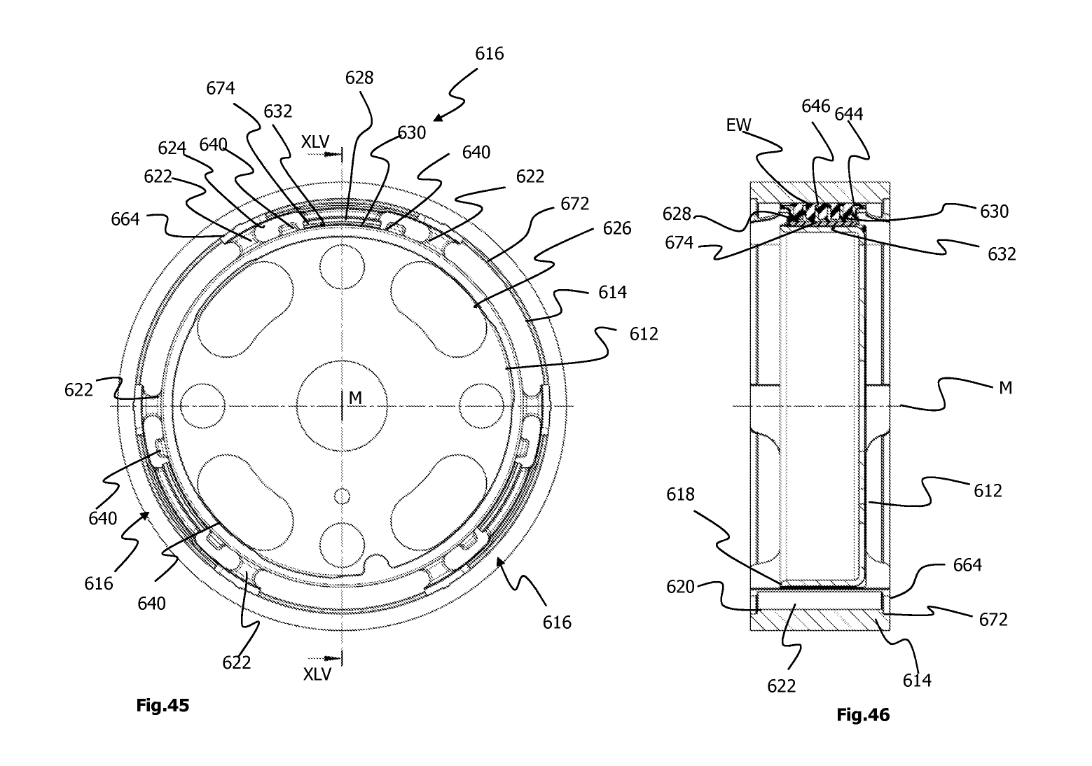

FIG. 45 is a top view of the rotary oscillation damper according to the seventh embodiment of the invention;

FIG. 46 is a sectional view along the cutting line XLV-XLV shown in FIG. 39;

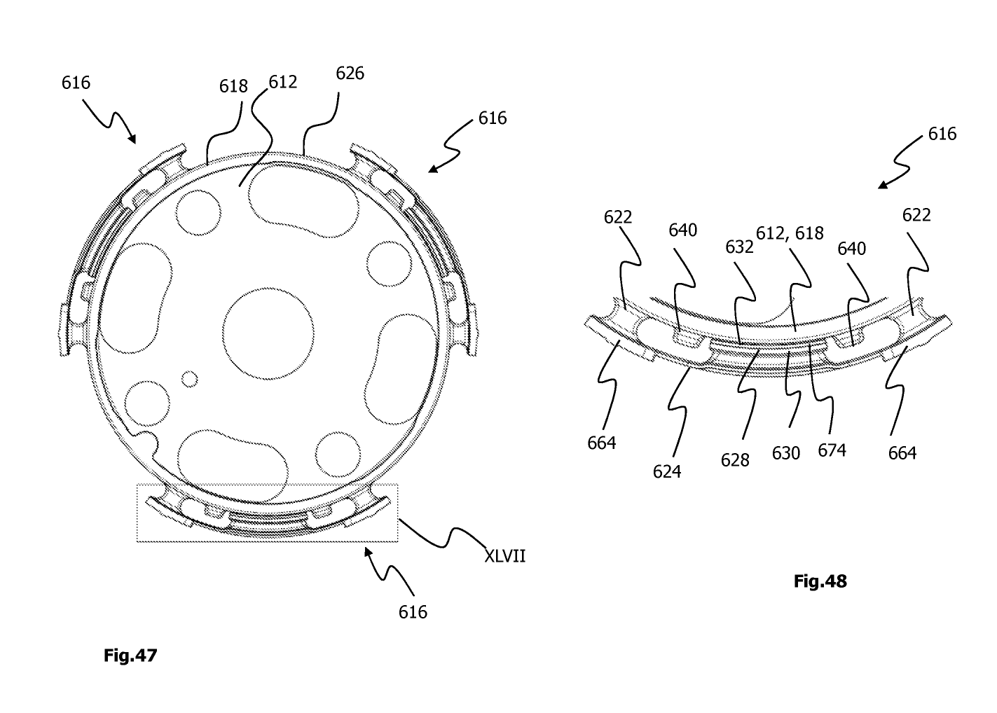

FIG. 47 is a top view of the inner part with a spring mechanism of the rotary oscillation damper according to the seventh embodiment of the invention;

FIG. 48 is an enlarged view of the detail XLVII from FIG. 48;

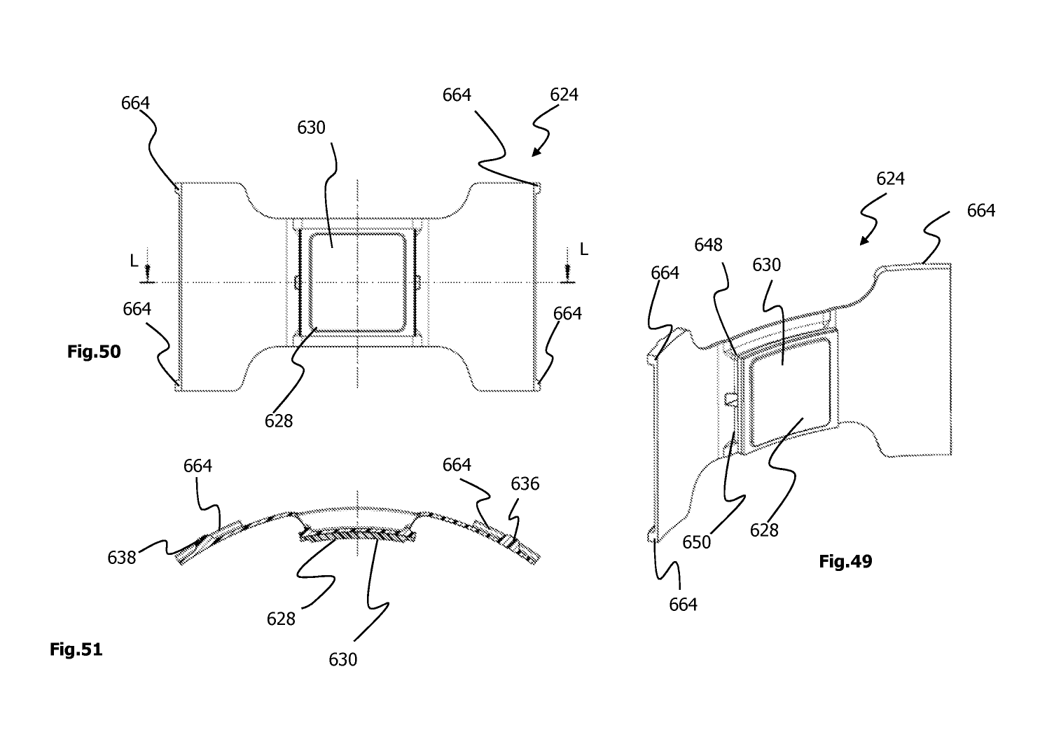

FIGS. 49-51 show views of a coupling device according to the seventh embodiment;

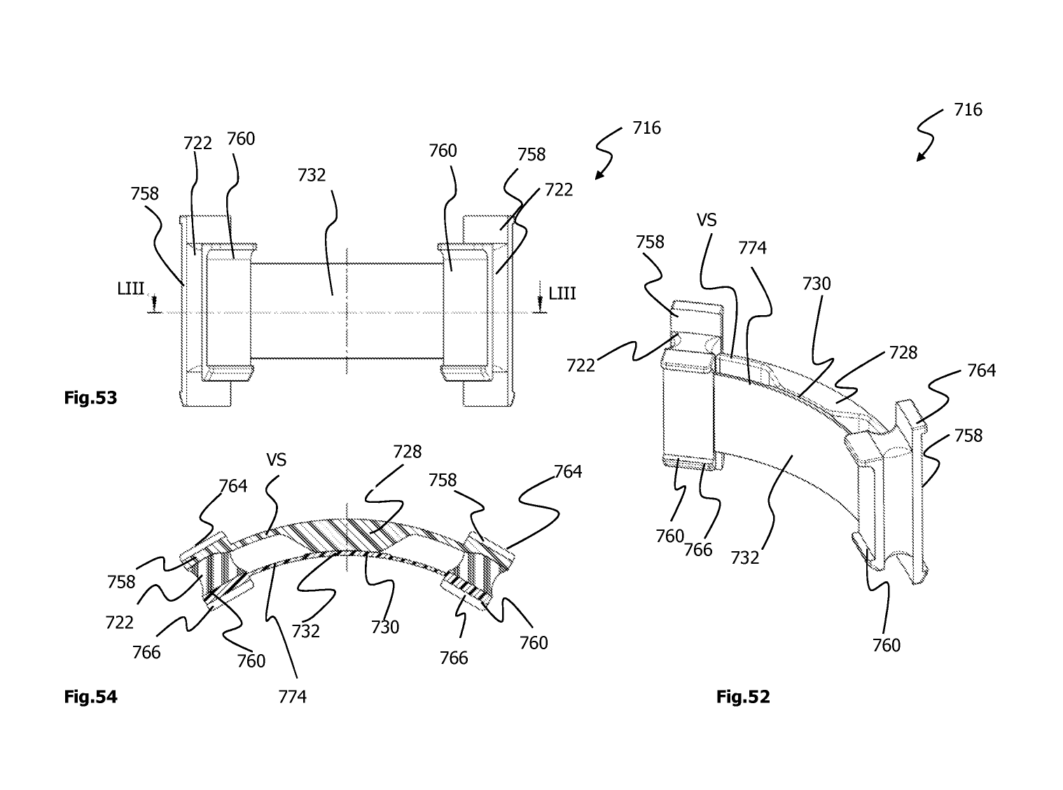

FIGS. 52-54 show views of a spring mechanism according to an eighth embodiment; and

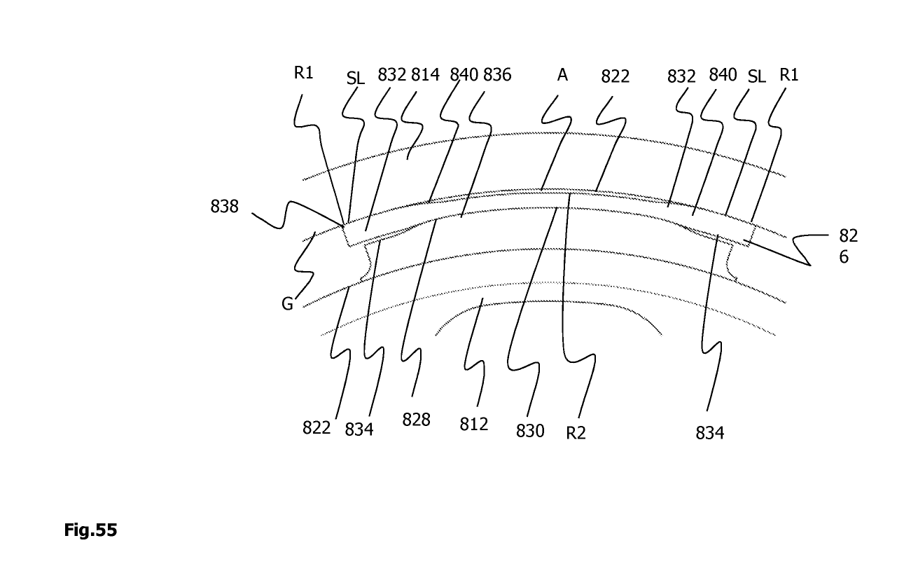

FIG. 55 is a top view of another exemplary embodiment of a sliding element.

FIG. 1 shows a perspective view of a rotary oscillation damper according to a first embodiment of the invention, which is labeled as a whole with the numeral 10.

The rotary oscillation damper 10 has an inner part 12 and a damper mass 14. The inner part 12 and the damper mass 14 are connected to each other by means of spring mechanisms 16. The damper mass 14 extends around the inner part 12 and is spaced apart from it in the radial direction. The spring mechanisms 16 are affixed to the outer circumference surface 18 of the cup-shaped inner part 12 and to the inner circumference surface 20 of the annular damper mass 14. The spring mechanisms 16 have spring elements 22 and coupling devices 24 extending in the radial direction. The coupling devices 24 connect two adjacent spring elements 22 to each other. Except for the coupling device 24, the spring mechanisms 16 are composed of an elastic material EW such as rubber or an elastomer. The elastic material EW in this case also extends for the most part around the outer circumference surfaces 18 of the inner part 12, as is visible in the section labeled with the numeral 26.

The coupling devices 24 have sliding elements 28. The sliding elements 28 are situated between the adjacent spring elements 22, which are connected to each other by means of the coupling device 24. The sliding elements 28 have sliding surfaces 30, which slide on sliding surface sections 32 on the outer circumference surface 18 of the inner part 12. There is no elastic material EW in the sliding surface sections 32, i.e. the sliding surface 30 of the sliding elements 28 slides directly on the inner part 12.

FIG. 2 shows a perspective view of the inner part 12 with the spring mechanisms 16 affixed to it. The coupling devices 24 extend over a predetermined circumference section of the outer circumference surface 18 of the inner part 12. The coupling devices 24 are embodied as plate-shaped and are provided with a curvature that has a larger radius than that of the outer circumference surface 18 of the inner part 12. On the outer surfaces 34 of the coupling devices 24, projections or bulges 36 are visible, by means of which a form-fitting engagement with the inner circumference surface 20 of the damper mass 14 can be produced (see FIG. 1). The coupling devices 24 can, for example, be made of a plastic. The projections or bulges 36 are embodied as cross-shaped so that they can secure the damper mass 14 to the inner part 12 both in the axial direction and in the circumference direction. The bulges 36 thus have one segment that extends in the axial direction and one segment that extends in the circumference direction.

As is visible in FIG. 2, the sliding elements 28 are formed directly onto the coupling devices 24, i.e. the coupling devices 24 and the sliding elements 28 form a component.

FIG. 3 shows a perspective view of the inner part 12 and the damper mass 14 of the rotary oscillation damper 10, with the components separated from one another.

In the inner circumference surface 20 of the damper mass 14, recesses 38 are visible, which are embodied as complementary to the projections or cross-shaped bulges 36 on the outer surfaces 34 of the coupling devices 24 and cooperate with these bulges. The recesses 38 and the projections 36 produce a form-fitting engagement, which secures the damper mass 14 to the inner part 12 and to the spring mechanisms 16. The inner part 12 is vulcanized to the spring mechanisms 16. The inner part 12 and its spring mechanisms 16 are press-fitted into the damper mass 14 in the axial direction until the form-fitting engagement is produced between the recesses 38 and the projections 36. The press-fitting of the spring mechanisms 16 into the damper mass 14 sets the prestressing of the spring mechanisms 16 in the radial direction. In other words, the inner part 12 and the damper mass 14 are connected to each other by means of the spring mechanisms 16 so that the spring mechanism 16 is acted on with a predetermined prestressing. The prestressing of the spring mechanism 16 can be matched to the respective intended use

FIG. 4 shows a top view of the rotary oscillation damper 10.

FIG. 4 shows the inner part 12 and the damper mass 14, which are connected by means of the spring mechanisms 16. The spring mechanisms 16 have stop elements 40, which serve to limit the relative rotation between the damper mass 14 and the inner part 12. The stop elements 14 are correspondingly used to set the amplitude of the torsional rotating oscillations. The stop elements 40 cooperate with the sliding elements 28 to limit the relative rotation. After a predetermined rotation or a predetermined amplitude, the sliding element 28 comes into contact with a stop element 40. The stop elements 40 are distributed at predetermined angular distances around the rotation axis M of the rotary oscillation damper 10. The stop elements 40 in this case are situated between a spring element 22 and a sliding element 28. The sliding element 28 slides with its sliding surface 30 on the sliding surface section 32 on the outer circumference surface 18 of the inner part 12 before it comes into contact with one of the stop elements 40. The sliding elements 28 serve to support the damper mass in the radial direction. Between the sliding surface 30 and the sliding surface section 32 on the inner part 12, there is a small air gap that is not visible in FIG. 2. The rigidity of the rotary oscillation damper 10 in the radial direction can be correspondingly set by means of the sliding elements 28.

FIG. 5 shows a sectional view along the cutting line IV-IV shown in FIG. 4.

FIG. 5 shows a spring element 22, which extends between the outer circumference surface 18 of the inner part 12 and the inner surface 42 of the coupling device 24. FIG. 5 also shows the recesses 38 in the inner circumference surface 20 of the damper mass 14, which cooperate with the projection 36 on the outer surface 34 of the coupling device 24.

The coupling devices 24 or more precisely their sliding elements 28, have chambers 44, which are situated on a surface 46 of the sliding element 28 oriented away from the sliding surface 30. These chambers 44 are filled with and enclosed by the elastic material EW, which is used for producing the spring mechanism 16. As a result, with the vulcanization of the spring mechanism 18, the elastic material EW pulls the sliding elements 28 in the direction of the inner part 12 so that the smallest possible air gap is set between the sliding surfaces 30, the sliding elements 28, and the sliding surface sections 32 of the inner part 12.

FIG. 6 shows a top view of the inner part 12 with the spring mechanisms 16 affixed to it.

The coupling devices 24 are embodied with a curvature that has a larger radius around the rotation axis M than the outer circumference surface 18 of the inner part 12. The coupling devices 24 are essentially embodied in the form of segments of a circle, with the sliding elements 28 protruding radially inward. In addition, the curvature of the coupling devices 14 is adapted or matched to the radius of the inner circumference surface 20 of the damper mass 14.

FIG. 7 shows a sectional view along the cutting line VI-VI from FIG. 6.

FIG. 7 shows that the outer surface 34 or the surface section 46 of the coupling devices 24 is at least partly enclosed by the elastic material EW.

FIG. 8 shows a perspective view of the coupling devices 24. On the outer surface 34, the projections 38 and chambers 44 are visible, which are situated in the vicinity of the sliding elements 28 in the surface section 46. As is also visible in FIG. 8, the chambers 44 are filled with the elastic material EW. The elastic material EW also extends across the surface section 46 of the outer surface 34. This surface section 46 essentially corresponds to the sliding elements 28.

FIG. 9 shows another perspective view of the coupling devices 24. The sliding elements 28 have openings 50 on their side surfaces 48 that extend essentially in the radial direction. During the manufacture of the rotary oscillation damper 10, the elastic material EW is conveyed into the chambers 44 through the openings 50.

FIGS. 8 and 9 also show the section 26 of the elastic material EW, which rests against the outer circumference surface 18 of the inner part 12 in the vulcanized state.

Another embodiment of the invention will be described below. Components that are the same or function in the same way have been provided with the same reference numerals as in the first embodiment, but with one additional digit.

FIG. 10 shows a perspective view of the rotary oscillation damper 110.

The rotary oscillation damper 110 has an inner part 112 and a damper mass 114, which are connected to each other by means of spring mechanisms 116. The spring mechanisms 116 include spring elements 122, which are connected by means of coupling devices 124 in the form of coupling plates. The spring mechanisms 116 also include a damping element 152 on which a sliding element 128 is situated. According to this embodiment, the elastic material EW of the spring mechanisms 116 extends around the entire outer circumference surface 118 of the inner part 12.

FIG. 11 shows a perspective view of the inner part 112 with the spring mechanism 116 affixed to it.

The spring mechanisms 116 have the spring elements 122, which are each provided with a respective coupling plate 124. The spring elements 122 with their coupling plates 124 are situated distributed at predetermined angular distances around the outer circumference surfaces 118 of the inner part 112. The damping elements 152 are each embodied with a respective sliding element 128. The damping elements 152 and the sliding elements 128 can be used to set the rigidity of the rotary oscillation damper 110 in the radial direction.

FIG. 12 shows a perspective view of the inner part 112, which has the spring mechanism 116 affixed to it, and the damper mass 114, with the components separated from one another.

The damper mass 114 has recesses 138, which extend over the entire axial span of the damper mass 114. The inner part 112 is inserted together with the spring mechanism 116 into the damper mass 114 in the axial direction. The coupling plates 124 engage in the recesses 138 in the inner circumference surface 120 of the damper mass 114. The insertion or press-fitting of the spring mechanism 116 acts on the spring mechanism 116 with a predetermined prestressing. The spring mechanism 116 is vulcanized directly onto the outer circumference surface 118 of the inner part 112. The spring elements 122 extend in the radial direction in such a way that the insertion of the spring mechanism and its spring elements 122 causes the spring elements 122 to be acted on with a predetermined radial prestressing.

The sliding elements 128 have a radius, which is matched to the radius of the inner circumference surface 120 of the damper mass 114. The sliding elements 128 have a sliding surface 130. The sliding surface 130 slides on sliding surface sections 154 on the inner circumference surface 120 of the damper mass 114.

FIG. 13 shows a top view of the rotary oscillation damper 110.

The inner part 112 is connected to the damper mass 114 by means of the spring elements 122 and the coupling plates 124. To this end, the coupling plates 124 are accommodated in the recesses 138 in the damper mass 112.

The sliding elements 128 slide with their sliding surface 130 on sliding surface sections 154 on the inner circumference surface 118 of the damper mass 112. The sliding surface sections 154 are each situated between two respective adjacent spring elements 122.

FIG. 14 shows a sectional view along the cutting line XIII-XIII shown in FIG. 13.

FIG. 14 shows the spring elements 122 and the coupling elements 124 affixed to it. The coupling plates 124 extend along the inner circumference surface 118 of the damper mass 114, i.e. the coupling elements 124 have the same axial span as the damper mass 114.

The sliding elements 128 are for the most part embedded in the elastic material EW and have a fastening section 156, which extends radially inward starting from the sliding surface 130 and is embedded in the elastic material EW. The fastening section 156 has a smaller span in the axial direction than the sliding surface 130. The sliding element 128 is correspondingly embodied with a stepped cross-section.

FIG. 15 shows a perspective view of a rotary oscillation damper 210 according to a third embodiment of the invention.

The rotary oscillation damper 210 includes a cup-shaped inner part 212 and a damper mass 214. The inner part 212 and the damper mass 214 are connected by means of spring mechanisms 216. The spring mechanisms 216 extend essentially in the radial direction between the inner part 212 and the damper mass 214. The spring mechanisms 216 have a coupling device 224 for connecting to the inner part 212 to the damper mass 214. According to this embodiment, the coupling device 224 is composed of two coupling elements 258 and 260, which are connected to each other by means of a spring element 222. The coupling element 258 is accommodated in a recess 238 in the damper mass 214. The recess 238 is provided in the inner circumference surface 220 of the damper mass. The inner part 212 or its outer circumference surface 218 has recesses 262 embodied in it, in which the coupling element 260 is accommodated. In all of the embodiments of the invention, the inner part 212 can be a deep-drawn part into which the recesses or indentations 262 are formed.

FIG. 16 shows a perspective view of the cup-shaped inner part 212 with the indentations or recesses 262 in the outer circumference surface 218 of the inner part 212. The spring mechanisms 216 each have two respective coupling elements 258, 260, which are connected to each other by means of a spring element 222. The coupling elements 258, 260 have respective detent devices or detent lugs 264, 266 for connecting to the inner part 212 and the damper mass 214. The detent lugs 264, 266 also serve to secure the spring mechanism 216 on the rotary oscillation damper 210 in the axial direction of the center axis of the rotary oscillation damper 210. To accomplish this, sections of the detent lugs 264, 266 rest against radial sections of the inner part 212 and damper mass 214 in the vicinity of the recesses 238 and 262.

FIG. 17 shows a perspective view of the damper mass 214 and spring mechanisms 216 according to the third embodiment of the invention.

FIG. 17 shows the recesses 238 in the damper mass 214 and in its inner circumference surface 220. The recesses 238 have radial contact surfaces 268, which are offset inward in the axial direction and against which the detent lugs 264 on the coupling element 258 can come to rest, and thus serve to secure the spring mechanisms 216 in the axial direction.

FIG. 18 shows a top view of the rotary oscillation damper 210. The spring mechanisms 216 extend in the radial direction between the inner part 212 and the damper mass 214. The coupling element 258 is accommodated in a recess 238 in the damper mass 214. The inner part 212 has recesses 262, which are embodied in the outer circumference surface 218 of the inner part 212.

As is particularly clear from FIGS. 17 and 18, the spring mechanisms 216 are modular assemblies, which can be vulcanized separately. The spring mechanisms 216 are press-fitted between the damper mass 214 and the inner part 212 and in so doing, are provided with a radial prestressing.

FIG. 19 shows a sectional view along the cutting line XVIII-XVIII shown in FIG. 18.

FIG. 19 shows the spring mechanism 216, which has a coupling device 224. The coupling device 224 includes two coupling elements 258 and 260. The coupling element 258 has detent lugs 264 extending in the radial direction, which cooperate with a radial wall section 268 on the damper mass 214 in order to secure the spring mechanism 216 in the axial direction. The coupling element 260 likewise has detent lugs 266 extending in the radial direction. The detent lug 266 on the left side of the coupling element 260 in FIG. 19 cooperates with the axial end surface of the cup-shaped inner part 212. The right-side detent lug 260 [sic] extending farther in the radial direction cooperates with a surface section of the radially extending fastening surface 270 of the cup-shaped inner part 212. The fastening surface 270 is used to fasten the rotary oscillation damper 210 to a shaft section (not shown).

FIG. 20 shows a perspective view of a rotary oscillation damper 310 according to a fourth embodiment of the invention.

The fourth embodiment of the invention largely coincides with the above-described third embodiment of the invention. In addition to the third embodiment described with reference to FIGS. 15 through 19, the rotary oscillation damper 310 has a sliding element 328, which is situated between two spring mechanisms 316 and its sliding surface 330, can slide on a sliding surface section 354 of the inner circumference surface 320 of the damper mass 314.

FIG. 21 shows a perspective view of the inner part 314 and spring mechanism 316 as well as the sliding member 328.

In addition to the recesses 362 for accommodating the coupling element 360 of the spring mechanisms 316, the inner part 312 also has recesses 372 on its outer circumference surface 318. The recesses 372 cooperate with the surface 374 of the sliding elements 328 oriented toward the inner part 312 and with the detent elements 376 of the sliding element 328. The detent element 376 can thus be accommodated with its surface 374 in the recesses 372 and can be secured to the inner part in the axial direction by means of the detent lugs 376.

The detent projections 376 have detent lugs 378 protruding in the axial direction, which can be accommodated in a recess 380 in the surface 370. The detent recess 380 is situated in the vicinity of the recess or indentation 372 and can cooperate with the detent lugs 378 on the sliding element 328.

FIG. 22 shows a perspective view of the damper mass 314, the spring mechanisms 316, and the sliding members 328.

FIG. 23 shows a top view of the rotary oscillation damper 310.

The top view in FIG. 23 shows the sliding members 328, which are embodied in the form of segments of a circle and whose cross-sections decrease in the direction of the detent projections 376. The rotary oscillation damper 310 includes three sliding members 328, which are respectively provided offset from one another by 120 degrees between two adjacent spring mechanisms 316. The spring mechanisms 316 are respectively situated offset from one another by 60 degrees. The same is true of the recesses 338 in the damper mass 314 and the recesses 362 in the inner part 312. The recesses 372 for accommodating the sliding member 328 are offset from one another by 120 degrees. The sliding members 328 have an arched sliding surface 330. The sliding surface 330 is matched to the radius of the inner circumference surface so that it can rest against and slide on the sliding surface section 354 of the inner circumference surface 320 of the damper mass 312.

FIG. 24 shows a sectional view along the cutting line XXIII-XXIII shown in FIG. 23.

FIG. 24 shows the detent projections 376 of the sliding member 328. The detent projections 376 have detent lugs 378 formed onto them, which on the one hand engage behind the axial end surface of the cup-shaped inner part 312 (see left side of FIG. 24). In addition, the detent lugs 378 shown on the right side in the axial direction in FIG. 24 engage into the recess 380 in the surface 370 of the inner part 312 extending in the radial direction.

The spring mechanisms 316 once again include a coupling device 324 with a coupling element 358 and an additional coupling element 360. The coupling elements 358 and 360 are connected to each other by means of a spring element 322. The coupling element 360 has detent lugs 366 for axially securing the spring mechanism 316 to the inner part 312. The coupling element 358 has detent lugs 364, which cooperate with a radially extending wall section 368 on the damper mass 314 to axially secure the spring mechanism 316 on the damper mass 312.

Also according to this embodiment, the spring mechanisms 316 are modular assemblies, which can be press-fitted between the damper mass 314 and the inner part 312.

FIG. 25 shows a perspective view of a rotary oscillation damper 410 according to a fifth embodiment of the invention.

The rotary oscillation damper 410 has a damper mass 414 and an inner part 412. The inner part 412 and the damper mass 414 are connected to each other by means of spring mechanisms 416. The spring mechanism 416 includes a coupling device 424. The coupling device 424 respectively has two coupling elements 458 and two coupling elements 460. The coupling elements 458 are connected to each other. The sliding element 428 is provided on the connecting piece VS between the coupling elements 458. The sliding element 428 protrudes in the direction of the outer circumference surface 418 of the cup-shaped inner part 412. The sliding element 428 has a sliding surface 430, which slides on the sliding surface section 432 of the outer circumference surface 418 of the inner part 412.

FIG. 26 shows a perspective view of the inner part 412 and spring mechanisms 416. The inner part 412 has recesses 462 in its outer circumference surface 418, which cooperate with the coupling element 460 and its detent lugs 466. The spring elements 416 include a coupling device 424. The connecting piece VS between the coupling elements 458 is embodied as arched and in the installed state of the coupling device 424 and spring mechanism 416, can be brought into contact with the inner circumference surface 420 of the damper mass 414.

FIG. 27 shows a perspective view of the damper mass 414 and spring mechanisms 416.

FIG. 28 shows a perspective view of the spring mechanism 416. The spring device 416 includes the coupling device 424. The coupling device has coupling elements 458 and 460, which are connected by means of respective spring elements 422. The coupling elements 458 are connected to each other by means of a connecting piece VS with the outer surface 434. On the connecting piece VS, the sliding elements 428 are provided with their sliding surface 430. The coupling elements 458 and 460 have respective detent projections and detent lugs 464, 466, which cooperate with the recesses in the inner part 412 and the damper mass 414 (see FIGS. 25 through 27).

FIG. 29 shows a top view of the spring mechanism 416. The spring mechanisms 416 are embodied as arched in order to match the circular design of the damper mass 414 and inner part 412.

FIG. 30 shows a sectional view along the cutting line XXIX-XXIX shown in FIG. 29.

FIG. 30 shows the curved or bowed shape of the spring devices 416. The coupling elements 458 are connected to each other by means of the connecting piece VS with the outer surface 434. The sliding elements 428 are provided on the connecting piece VS. The coupling elements 458 and the connecting piece VS with the sliding element 428 are embodied of one piece and are of the same material. On the coupling elements 458, 460, the detent lugs 464, 466 are visible. The spring mechanisms 416 are modular assemblies, which can be press-fitted between the damper mass 414 and inner part 412 (FIG. 25).

FIG. 31 shows a top view of the rotary oscillation damper 410.

The spring mechanisms 416 are offset from one another by 120 degrees. The sliding element 428 has a sliding surface 430, which slides on the sliding surface section 432 of the outer circumference surface 418 of the inner part 412.

FIG. 32 shows a sectional view along the cutting line XXXI-XXXI shown in FIG. 31.

FIG. 32 shows the spring mechanisms 416 with the coupling device 426 and the sliding elements 428, which extend between the outer circumference surface 418 of the inner part 412 and the inner circumference surface 420 of the damper mass 414.

FIG. 33 shows a perspective view of a rotary oscillation damper 510 according to a sixth embodiment of the invention.

The rotary oscillation damper 510 once again has spring mechanisms 516 with coupling devices 528. According to this embodiment, the coupling device 524 also respectively includes two coupling elements 558 and two coupling elements 560. The coupling elements 560 are accommodated in recesses 562 in the inner part 512. The coupling elements 560 are connected to one another by means of a connecting piece VS that has the outer surface 534. The outer surface 534 rests against the outer circumference surface 518 of the inner part 512. The connecting piece VS with the outer surface 534 is equipped with the sliding members 528. The sliding members 528 have a sliding surface 530, which slides on the sliding surface section 554 of the inner circumference surface 520 of the damper mass.

FIG. 34 shows a perspective view of the inner part 512 and spring mechanisms 516.

FIG. 35 shows a perspective view of the damper mass 514 and spring mechanisms 516.

FIG. 36 shows a perspective view of the spring mechanisms 516 with the coupling devices 524.

The coupling devices 524 include coupling elements 558 that are affixed to the damper mass 512 and coupling elements 560 that are affixed to the inner part 512.

The coupling parts 560 are connected to each other by means of the connecting piece VS with the outer surface 534. The connecting piece has the sliding elements 528 with their sliding surfaces 530.

Together with the sliding members 528, the spring mechanisms 516 are a modular assembly, which can be press-fitted with the inner part 512 and the damper mass 514.

FIG. 37 shows a top view of the spring mechanisms 516.

FIG. 38 shows a sectional view along the cutting line XXXVII-XXXVII shown in FIG. 37.

FIG. 38 shows the coupling elements 558 with their detent projections 564. The coupling elements 558 are connected to the coupling elements 560 by means of spring elements 522. The coupling elements 560 likewise have detent projections 566. The coupling elements 560 are connected to each other by means of the connecting piece with the outer surface 534. The spring mechanisms 516 are embodied as arched in order to be able to be press-fitted between the inner circumference surface 520 of the damper mass 514 and the outer circumference surface 518 of the inner part 512. The press-fitting of the spring mechanisms 516 prestresses the spring mechanisms 516 and their spring elements 522.

FIG. 39 shows a top view of the rotary oscillation damper 510.

The spring mechanisms 516 have the coupling elements 558 and 560. The coupling elements 560 are connected to each other by means of the connecting piece VS with the outer surface 534. The surface 534 rests against the outer circumference surface 518 of the inner part 512. The coupling elements 516 are provided radially inside the coupling elements 558. The sliding elements 528 are embodied on the connecting piece VS and slide on the sliding surface section 554 with their sliding surface 530.

FIG. 40 shows a sectional view along the cutting line XXXIX-XXXIX shown in FIG. 39.

FIG. 40 once again shows the cup-shaped inner part 512 and the damper mass 514, which are connected to each other by means of the spring mechanisms 516. The sliding member 528 can slide with its sliding surface 530 on the sliding surface section 554 of the inner circumference surface 520 of the damper mass 512.

FIG. 41 shows a perspective view of a rotary oscillation damper 610 according to a seventh embodiment of the invention.

The rotary oscillation damper 610 includes the inner part 612 and the damper mass 614, which are connected to each other by means of spring mechanisms 616. The spring mechanisms 616 have spring elements 622 and coupling devices 624 extending in the radial direction, which according to this embodiment, cooperate with a circumferential recess 672 in the inner circumference surface 620 of the damper mass 614 and in this way, couple the damper mass 614 to the spring mechanisms 616 and to the inner part 612.

FIG. 42 shows a perspective view of the damper mass 614 and inner part 612 with the spring mechanisms 616 affixed to it, when the inner part 612 and the damper mass 614 are separated from each other.

The circumferential recess 672 in the damper mass 614 is visible. A recess 638 extending in the direction of the center axis M of the rotary oscillation damper 610 is visible in FIG. 42. The coupling device 624, which is embodied in the form of an arched plate according to this embodiment, has coupling or detent elements 664 and 636 on its outer surface, which cooperate with the grooves 638 and 672 in the damper mass 614. If the inner part 612 is press-fitted together with the spring mechanisms 616 into the damper mass 614, then the detent elements 636 and 664 come into engagement with the recesses 638 and 672 and secure the damper mass 614 to the inner part 612 in both the axial direction and circumference direction. The inner part 612 with the spring mechanisms 616 can be press-fitted into the damper mass 614 in order to prestress the spring mechanisms 616 in the radial direction.

FIG. 43 shows a perspective view of the inner part 612 with the spring mechanisms 616 affixed to it. FIG. 43 shows that the outer surface 634 of the coupling devices 624, which is oriented away from the outer circumference surface 618 of the inner part 612, is at least partially covered by the elastic sheath EW. On the outside 634, the detent elements 636 and 664 are once again visible. The coupling devices 624 have sliding elements 628 with a sliding surface 630. According to this embodiment, the sliding elements 628 do not slide directly on the outer circumference surface 618 of the inner part 612, but instead cooperate with a sliding member 632 on the outer circumference surface 618 of the inner part 612 of the damper. The sliding member 632 defines a sliding surface section 674, which cooperates with the sliding surface 630 of the sliding member 628.

FIG. 43 also shows the stop elements 40, which limit a relative movement between the inner part 612 and the damper mass 614.

FIG. 44 shows an enlarged view of the detail XLIII-XLIII in FIG. 43.

The sliding members 628 and 632 contact one another and have a similar curvature, which is matched to the radius of the outer circumference surface 618 of the inner part 612.

The sliding member 632 on the outer circumference surface 618 of the inner part 612 is provided between the spring elements 622 of the spring mechanism 616 and between the stop elements 640. The sliding member 632 is connected to the rubber-elastic sheath EW, which according to this embodiment, encompasses the entire outer circumference surface 618 of the inner part 612.

FIG. 45 shows a top view of the rotary oscillation damper 610, in which the sliding members 628 and 632 are visible. The sliding members 628 and 632 contact each other by means of their sliding surfaces 630 and 674. The circumferential recess 672 cooperates with the detent elements 664 in order to secure the damper mass 614 to the spring mechanisms 616.

FIG. 46 shows a sectional view along the cutting line XLV-XLV shown in FIG. 45.

The sliding surface 674 of the sliding member 632 affixed to the outer circumference surface 618 of the inner part 612 of the damper comes into contact with the sliding surface 630 of the sliding member 628, which is provided radially outside the inner circumference surface 620 of the inner part of the damper 612. With a relative movement between the inner part 612 and the damper mass 614, the sliding member 628 can slide with its sliding surface 630 on the sliding surface 674 of the sliding member 632. The coupling devices 624 or the sliding members 628 have chambers 644, which are situated in a surface 646 of the sliding element 628 oriented away from the sliding surface 630. These chambers 644 are filled with and enclosed by the elastic material EW.

FIG. 47 shows a top view of the inner part 612 with the spring mechanisms 616.

FIG. 48 shows an enlarged view of the detail XLVII in FIG. 47.

FIG. 48 shows the sliding members 628 and 632, whose sliding surfaces 674 and 630 rest against each other. The sliding members 628, 632 are provided between the stop elements 660 or spring elements 622 of a spring mechanism 616.

The coupling device 624 has a curvature that is adapted to the radius of the inner circumference surface 620 of the damper mass 614 (see FIG. 45). Also visible are the detent elements 664, which serve to secure the damper mass 614 to the inner part of the damper 612.

FIG. 49 shows a perspective view of the coupling devices 624.

The coupling devices 624 are embodied of one piece with the sliding elements or sliding members 628, which have a sliding surface 630. The coupling devices 624 have detent elements 664 on their end surfaces in the axial direction of the center axis of the rotary oscillation damper 610 (see FIG. 45).

FIG. 49 also shows the openings 650, which are provided in the radially extending side surfaces 648 of the sliding members 628.

FIG. 50 shows a top view of the coupling device 624, which once again shows the sliding members 628 that are embodied of one piece with the coupling device 624. The cross-section of the coupling device 624 decreases in the vicinity of the sliding elements 628.

FIG. 51 shows a sectional view along the cutting line L-L shown in FIG. 50.

The coupling device 624 includes the detent elements 638, which extend in the axial direction, and the detent elements 664. The sliding members 628 with their sliding surfaces 630 are made of a different material than the rest of the coupling device 624. The material for the sliding members 628 can, for example, be a harder plastic.

FIG. 52 shows another embodiment of a spring mechanism 716.

According to this embodiment, the coupling device 724 includes coupling elements 758 and 760. The coupling element 758 is used to produce a coupling with a damper mass, not shown, and the coupling element 760 is used to produce a coupling with an inner part 712, not shown. The coupling elements 758 and 760 are connected to each other by means of spring elements 722. The coupling elements 758 are connected to each other by means of a connecting piece VS. A sliding member 728 is provided on the connecting piece VS. The coupling elements 760 are connected by means of a sliding member 732 to a sliding surface 774 that can extend along an outer circumference surface of an inner part, not shown.

In order to produce a coupling with the inner part, not shown, and the damper mass, not shown, the coupling elements 758, 760 have respective detent devices or detent lugs 764 and 766, which are used to secure the spring mechanism 716 to the rotary oscillation damper 710 also in the axial direction of the center axis of the rotary oscillation damper (not shown).

FIG. 53 shows a top view of the spring mechanism 716.

FIG. 54 shows a sectional view along the cutting line LIII-LIII shown in FIG. 53.

On the connecting piece VS, the coupling element 758 has the sliding member 728 with its sliding surface 730. The coupling element 760 has a sliding member 732 with a sliding surface 774 on which the sliding member 728 can slide. The spring mechanism 716 can be press-fitted between the inner circumference surface of the damper mass (not shown) and the outer circumference surface of the inner part (not shown) and can thus connect the inner part to the damper mass. The press-fitting of the spring mechanism 716 provides the spring mechanism 716 with a prestressing. The spring mechanism 716 is a modular assembly that can be connected by means of a form-fitting engagement to a damper mass and an inner part (both not shown) with radial prestressing. The spring mechanism 716 can be vulcanized independently from the rest of the components of an oscillation damper.

FIG. 55 shows another exemplary embodiment of a sliding member, which is labeled below with the numeral 826.

FIG. 55 shows the sliding member 826, which is connected to the damping elements 828 by means of a connecting section 830, preferably with the aid of an adhesive coating. Starting from the connecting section 830, sliding surface sections 832 extend in the circumference direction of the oscillation damper 810, which set a setpoint air gap SL relative to a sliding surface G. The sliding surface G in this case is constituted by the inner circumference surface 818 of the mass ring 814.

By contrast with the connecting section 830, the sliding surface sections 832 are not connected to the damping element 828. Since the span of the sliding members 826 and the damping elements 828 in the circumference direction of the oscillation damper 810 is greater than the span of the connecting section 830 in the circumference direction of the oscillation damper 810, the sliding surface sections 832 extend, at least in a section 834, loosely and without an attachment to the damping element 828. The sliding surface sections 832 that are separate from the damping element 828 promote a “springy behavior” of the sliding member 826 or sliding surface sections 832, i.e. after the vulcanization of the damping elements 828, the sliding surface sections 832 can “spring” into their setpoint position and set a setpoint air gap SL relative to the inner circumference surface 818 of the mass ring 814, which can compensate for a shrinkage of the material of the damping elements 828 during the vulcanization.

FIG. 55 shows the irregular cross-section of the sliding members 826. The sliding members 26 have their greatest cross-section at the sliding surface sections 832 and have their smallest cross-section, i.e. the lowest material thickness, in the vicinity of the connecting section 830. This also contributes to the springy behavior of the sliding surface sections.

FIG. 55 also shows that the sliding members 826 are structurally embodied so that the surface 836 of the sliding members 826 that is connected to the damping elements 828 has a uniform curvature.

By contrast with the surface 836, the surface 838 of the sliding members 826 oriented toward the inner circumference surface 818 of the mass ring 814 is provided with different curvatures, i.e. with curvatures of different radii.

The sliding surface sections 832 in this case have a curvature at the surface 836 with a first radius R1, which is different from the curvature of the connecting section 830 with a second radius R2. Preferably, the radius R1 of the curvature of the sliding surface sections 832 is selected so that the curvature of the sliding surface sections 832 is adapted to the radius of the inner circumference surface 818 of the mass ring 814. The radius R2 of the curvature of the connecting section 830 is preferably selected to be greater than the radius R1 of the curvature of the sliding surface sections 832. These different radii R1 and R2 of the curvatures of the sliding surface sections 832 and of the connecting section 830 produce the distance A between the connecting region 830 and the inner circumference surface 822 of the mass ring 814. The distance A is greater than the setpoint air gap SL set by the sliding surface sections 832.

As is particularly clear from FIG. 55, the curvatures of the sliding surface sections 832, even in the transition regions 840, continuously transition into the curvature of the connecting region 830. The transition regions 840 can, however, also have opposing curvatures, i.e. the transition regions 840 can be arched in the direction of the surface 836 of the sliding members 826, depending on which radii R1, R2 have been selected for the curvatures of the sliding surface sections 832 and the connecting section 830.

During the vulcanization, the entire surface 836 of the sliding member 826 oriented toward the inner circumference surface 818 of the mass ring 814 rests against the inner circumference surface 818 due to the high pressure. Since the material of the damping elements shrinks during the vulcanization, the sliding member 826 or the connecting region, which is connected to the damping element 828, is recessed, so to speak, from the inner circumference surface 818.

But since the sliding surface sections 832 extend loosely on the damping element 828 in the section 834, they can flex in the direction of the inner circumference surface 818 of the mass ring 814 and can thus assume a setpoint position, consequently setting a setpoint air gap between the sliding surface sections 832 and the inner circumference surface 818 of the mass ring 814. The setting of the setpoint air gap can be used to reliably prevent imbalances and a jamming of the oscillation damper.

What is claimed is:

1. An oscillation damper, particularly for a drivetrain of a motor vehicle, having
at least one inner part that can rotate around a rotational axis,
at least one damper mass that is coaxial to the inner part and is situated spaced radially apart from the inner part, and
at least one spring mechanism that produces a connection between the at least one inner part and the at least one damper mass,
wherein the at least one inner part and the at least one damper mass can be connected by means of the at least one spring mechanism in such a way that the at least one spring mechanism has a predetermined radial prestressing.

2. The oscillation damper according to claim 1,
wherein the at least one spring mechanism has at least one spring element extending in the radial direction.

3. The oscillation damper according to claim 1,
wherein the at least one spring mechanism has at least one coupling device and the at least one coupling device is used for coupling the at least one spring mechanism to the at least one inner part and/or the at least one damper mass.

4. The oscillation damper according to claim 3,
wherein the at least one inner part and/or the at least one damper mass is/are provided with at least one complementary coupling device, which cooperates with the at least one coupling device of the at least one spring mechanism.

5. The oscillation damper according to claim 3,
wherein the at least one coupling device is connected to the at least one spring element.

6. The oscillation damper according to claim 3,
wherein the at least one coupling device connects adjacent spring elements.

7. The oscillation damper according to claim 1,
wherein the at least one spring mechanism has at least one sliding element.

8. The oscillation damper according to claim 7,
wherein the at least one sliding element is connected to the at least one coupling device.

9. The oscillation damper according to claim 7,
wherein the at least one sliding element has at least one chamber, which is embodied in a surface of the sliding element oriented away from sliding surface.

10. The oscillation damper according to claim 1,
wherein at least one stop element is provided, which limits a relative rotation between the at least one damper mass and the at least one inner part.

11. The oscillation damper according to claim 10,
wherein the at least one spring mechanism includes the at least one stop element.

12. The oscillation damper according to claim 1,
wherein the spring mechanism is vulcanized onto the at least one inner part or the at least one damper mass.

13. The oscillation damper according to claim 3,
wherein the at least one coupling device has at least one coupling element for coupling the at least one spring mechanism to the at least one damper mass and at least one additional coupling element for coupling the at least one spring mechanism to the inner part.

14. The oscillation damper according to claim 1,
wherein the at least one spring mechanism is a modular assembly to which the at least one damper mass and the at least one inner part can be connected with prestressing.

15. The oscillation damper according to claim 14,
wherein the assembly composed of the at least one spring mechanism can be vulcanized separately and the at least one spring mechanism can be affixed to the at least one damper mass and the at least one inner part, in particular by means of a form-fitting engagement or a nonpositive, frictional engagement.

16. The oscillation damper according to claim 7,
wherein the at least one sliding element is embodied of one piece with the at least one coupling device.

17. The oscillation damper according to claim 7,
wherein the at least one spring mechanism has at least two sliding elements whose sliding surfaces slide on each other.

18. The oscillation damper according to claim 7,
wherein the at least one sliding element is connected to the damping element by means of at least one connecting section and has at least one sliding surface section, which extends in the circumference direction of the oscillation damper starting from the at least one connecting section and sets a predetermined setpoint air gap relative to the at least one sliding surface.

19. The oscillation damper according to claim 18,
wherein the at least one sliding element is embodied so that in the vicinity of the at least one connecting section, the distance of the at least one sliding element from the sliding surface of the damper mass and/or of the inner part is greater than the setpoint air gap set by the at least one sliding surface section.

20. A drivetrain for a motor vehicle having an oscillation damper according to claim 1.
